(19) United States
(12) Patent Application Publication
(10) Pub. No.: US 2026/0150030 A1
(43) Pub. Date: May 28, 2026

(54) NETWORK CONTROLLED UE-TO-UE (U2U) RELAY LINK MAINTENANCE

(71) Applicant: Telefonaktiebolaget LM Ericsson (publ), Stockholm (SE)

(72) Inventors: Min WANG, Luleå (SE); Zhang ZHANG, Beijing (CN); Nithin SRINIVASAN, Köln (DE); Jan CHRISTOFFERSSON, Luleå (SE)

(73) Assignee: Telefonaktiebolaget LM Ericsson (publ), Stockholm (SE)

(21) Appl. No.: 19/114,713

(22) PCT Filed: Aug. 30, 2023
(86) PCT No.: PCT/CN2023/115752

§ 371 Date: Mar. 24, 2025

(30) Foreign Application Priority Data
Sep. 23, 2022 (WO) PCT/CN2022/120737

(51) Int. Cl. H04W 40/22; H04W 40/12; H04W 88/04

(52) U.S. Cl. CPC H04W 40/22; H04W 40/12; H04W 88/04

(57) ABSTRACT

The present disclosure is related to UEs, a network node, and methods for network controlled U2U relay link maintenance. A method at a first UE for performing a U2U communication with a second UE via one or more U2U relay UEs comprises: receiving, from a network node, a message indicating control information for the U2U communication; and communicating with the second UE and/or at least one of the one or more U2U relay UEs for the U2U communication based on at least the indicated control information.

### CROSS-REFERENCE TO RELATED APPLICATION(S)

This application claims priority to the PCT International Application No. PCT/CN2022/120737, entitled “NETWORK CONTROLLED UE-TO-UE (U2U) RELAY LINK MAINTENANCE”, filed on Sep. 23, 2022, which is incorporated herein by reference in its entirety.

### TECHNICAL FIELD

The present disclosure is related to the field of telecommunications, and in particular, to user equipments (UEs), a network node, and methods for network controlled UE-to-UE (U2U) relay link maintenance.

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink (SL) communications. Sidelink is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G NR standard. These new cellular services were motivated by the business and economic needs of making the 3^{rd} Generation Partnership Project (3GPP) ecosystem capable of supporting industrial requirements ranging from direct automotive communication between vehicles to industrial automation with Ultra-Reliable Low-Latency Communication (URLLC) for mission- and business-critical applications. However, these same technologies can also be used for consumers to enhance their communication experience. For instance, sidelink proximity services would allow devices to discover and communicate with one another at extremely high data rates and low latency, making them ideal for peer-to-peer gaming and streaming services as well as Augmented Reality (AR), Virtual Reality (VR), and other wearable device communications.

In contrast with uplink and downlink between a UE and a base station, where resource allocation and link adaptation are controlled by the network, in sidelink the device may perform both functions autonomously. In other words, the device gains more control of how to use network resources. At the same time, it is expected that 3GPP upcoming Release will introduce support for sidelink-based relaying and that in future releases multi-link relay will also be considered. Sidelink is also a candidate for future releases as an Industrial Internet of Things (IoT) enabler. By restricting the communication link to one hop, latency is greatly reduced, which is key to mission-critical industrial applications. Furthermore, sidelink is a potential solution for public safety ensuring direct communication or relayed communication between devices.

Another potential use case is multi-hop relaying where multiple sidelink connections are used to leap from/to device to achieve less power consumption, overcome link budget constraints, and enhance latency and reliability. Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide-area, local-area, and personal-area communications.

### SUMMARY

According to a first aspect of the present disclosure, a method at a first UE for performing a U2U communication with a second UE via one or more U2U relay UEs is provided. The method comprises: receiving, from a network node, a message indicating control information for the U2U communication; and communicating with the second UE and/or at least one of the one or more U2U relay UEs for the U2U communication based on at least the indicated control information.

In some embodiments, the message comprises at least one of: system information that carries cell specific configuration applicable to all UEs in a cell; a paging message that carries control information for one or more UEs that are paged; a Radio Resource Control (RRC) message that carries UE specific control information and/or cell specific control information; a Control Protocol Data Unit (PDU) of a protocol layer; a Medium Access Control (MAC) Control Element (CE); and L1 signaling. In some embodiments, the control information indicates one or more U2U relay UE candidates via which the first UE shall set up a U2U relay path to the second UE.

In some embodiments, the control information further indicates at least one of: one or more traffic types or services that shall be transmitted via a U2U relay UE; one or more identifiers (IDs) of the one or more U2U relay UE candidates; an indicator indicating whether a U2U relay UE that is not indicated by the control information can be selected by the first UE or not; an L2 configuration to be set up at the first UE based on a number of hops; a priority order of the one or more U2U relay UE candidates; a timer value indicating a maximum time period during which the first UE needs to provide a response message to the network node during a U2U relay path establishment procedure; a maximum number of the one or more U2U relay UE candidates that can be tried; and a maximum number of U2U relay UEs that are not indicated by the control information and that can be tried.

In some embodiments, data associated with a traffic type or a service that is not indicated by the control information is transmitted by the first UE over a Uu path while data associated with a traffic type or a service that is indicated by the control information is transmitted by the first UE over a U2U relay path. In some embodiments, the control information indicates that data associated with a traffic type or a service is to be transmitted by the first UE over a U2U path, a UE-to-Network (U2N) path, or a Uu path. In some embodiments, an ID of a U2U relay UE candidate comprises at least one of: an SL ID to identify a corresponding U2U relay UE candidate; a Uu ID to identify a corresponding U2U relay UE candidate; and a temporary ID assigned to a corresponding U2U relay UE candidate. In some embodiments, after the step of receiving the message and before the step of communicating with the second UE and/or the at least one U2U relay UE, the method further comprises at least one of: determining one of the U2U relay UE candidates indicated by the control information as a target U2U relay UE; starting a timer for the target U2U relay UE with the timer value indicated by the control information, wherein the step of communicating with the second UE and/or the at least one U2U relay UE comprises: performing a U2U relay path establishment procedure to set up a U2U relay path to the second UE via the target U2U relay UE.

In some embodiments, the method further comprises at least one of: stopping the timer when the first UE has successfully established the U2U relay path; declaring a failure event when the timer is expired; reselecting a different one of the U2U relay UE candidates when the timer is expired; reselecting a U2N relay UE when the timer is expired; and reselecting a Uu path when the timer is expired. In some embodiments, the L2 configuration indicated by the control information is applied by the first UE during the U2U relay path establishment procedure. In some embodiments, when the priority order of the one or more U2U relay UE candidates is indicated by the control information, a U2U relay path establishment procedure is attempted by the first UE towards each of the one or more U2U relay UE candidates in the indicated priority order. In some embodiments, the priority order is determined based on at least one of: one or more measurements between any two of the first UE, the second UE, and the one or more U2U relay UE candidates that have a direct link therebetween; and a load status at each of the one or more U2U relay UE candidates.

In some embodiments, when a common timer value for all U2U relay UE candidates is indicated by the control information, the method further comprises at least one of: starting a timer when a U2U relay path establishment procedure for establishing a U2U relay path to the second UE is initiated for the first time; stopping the U2U relay path establishment procedure when the U2U relay path to the second UE is successfully established; stopping the timer when the U2U relay path to the second UE is successfully established; stopping the U2U relay path establishment procedure when the timer is expired; stopping the U2U relay path establishment procedure when U2U relay path establishment procedures for all of the U2U relay UE candidates fail; declaring a failure event when the timer is expired; and declaring a failure event when U2U relay path establishment procedures for all of the U2U relay UE candidates fail. In some embodiments, when one or more other timer values, which are associated with one or more U2U relay UE candidates, respectively, are indicated by the control information, the method further comprises, for each of the other timer values, at least one of: starting another timer when a U2U relay path establishment procedure is started to be performed towards an associated U2U relay UE candidate; stopping the U2U relay path establishment procedure when the U2U relay path to the second UE is successfully established via the associated U2U relay UE candidate; stopping the other timer when the U2U relay path to the second UE is successfully established via the associated U2U relay UE candidate; stopping the U2U relay path establishment procedure, which is performed towards the associated U2U relay UE candidate, when the other timer is expired; stopping the U2U relay path establishment procedure, which is performed towards the associated U2U relay UE candidate, when the U2U relay path establishment procedure fails for the associated U2U relay UE candidate; starting a next U2U relay path establishment procedure, which is performed towards a next U2U relay UE candidate, when the other timer is expired; and starting a next U2U relay path establishment procedure, which is performed towards a next U2U relay UE candidate, when the U2U relay path establishment procedure fails for the associated U2U relay UE candidate.

In some embodiments, when separate timer values, which are associated with the U2U relay UE candidates, respectively, are indicated by the control information, the method further comprises, for each of the separate timer values, at least one of: starting a timer when a U2U relay path establishment procedure for establishing a U2U relay path to the second UE via an associated U2U relay UE candidate is initiated; stopping the U2U relay path establishment procedure when the U2U relay path to the second UE is successfully established via the associated U2U relay UE candidate; stopping the timer when the U2U relay path to the second UE is successfully established via the associated U2U relay UE candidate; stopping the U2U relay path establishment procedure when the timer is expired; stopping the U2U relay path establishment procedure when the U2U relay path establishment procedure fails for the associated U2U relay UE candidate; declaring a failure event when the timer is expired; declaring a failure event when the U2U relay path establishment procedure fails; starting a next U2U relay path establishment procedure, which is performed towards a next U2U relay UE candidate, when the timer is expired; and starting a next U2U relay path establishment procedure, which is performed towards a next U2U relay UE candidate, when the U2U relay path establishment procedure fails.

In some embodiments, the step of declaring a failure event comprises: transmitting, to the network node, the failure event together with an identifier of the associated U2U relay UE candidate. In some embodiments, when the control information indicates an L2 configuration to be set up at the first UE, the L2 configuration indicates at least one of: a number of hops involved; one or more measurements between any two of the first UE, the second UE, and the one or more U2U relay UE candidates that have a direct link therebetween; and an End-to-End (E2E) packet delay budge (PDB) required to support a service; and an E2E packet error rate (PER) required to support a service. In some embodiments, when the control information indicates only one U2U relay UE candidate, the method further comprises: in response to the first UE declaring a failure event associated with the U2U relay UE candidate indicated by the control information, receiving, from the network node a message indicating at least one of: another control information indicating another U2U relay UE candidate; that the first UE is to select another U2U relay UE candidate by itself; and that the first UE is to abort the U2U relay path establishment procedure.

In some embodiments, when the control information indicates multiple U2U relay UE candidates, whether a U2U relay path establishment procedure is performed towards one U2U relay UE candidate at a time or towards multiple U2U relay UE candidates at the same time is up to the first UE to determine. In some embodiments, the step of communicating with the second UE and/or the at least one U2U relay UE comprises: transmitting, to second UE and/or the at least one U2U relay UE, a discovery message or a link establishment request message indicating at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not. In some embodiments, a failure event is reported by the first UE to the network node via at least one of: RRC signaling; MAC CE; and L1 signaling. In some embodiments, the failure event indicates at least one of: a failure cause; an ID of the first UE; one or more U2U relay UE candidates to which one or more U2U relay path establishment procedures were attempted since the last failure event was reported; and whether the first UE is allowed to try additional U2U relay UE candidates.

In some embodiments, when a U2U relay path to the second UE is successfully established via at least one U2U relay UE, the method further comprises: monitoring and/or measuring the U2U relay path. In some embodiments, the U2U relay path is monitored and/or measured in terms of at least one of: one or more radio channel quality metrics on any hop between any two of the first UE, the second UE, and the at least one U2U relay UE that have a direct link therebetween; a transmission failure rate; a retransmission ratio; one or more Quality of Service (QoS) metrics; and one or more congestion metrics. In some embodiments, at least one of following is true: a radio channel quality metric comprises at least one of Reference Signal Received Power (RSRP), Reference Signal Received Quality (RSRQ), Received Signal Strength Indicator (RSSI), Signal to Interference plus Noise Ratio (SINR), Signal to Interference Ratio (SIR), and Block Error Rate (BLER); a transmission failure rate comprises at least one of a Hybrid Automatic Repeat Request (HARQ) failure rate and a Radio Link Control (RLC) Protocol Data Unit (PDU) failure rate; a retransmission ratio comprises at least one of a HARQ retransmission ratio and an RLC PDU retransmission ratio; a QoS metric comprises at least one of a bit rate, a packet delay, and a packet error rate; and a congestion metric comprises at least one of a channel busy ratio (CBR), a channel usage ratio (CR), a channel occupancy in case of unlicensed operation, a Listen-Before-Talk (LBT) success/failure ratio in case of unlicensed operation.

In some embodiments, the method further comprises: transmitting, to the network node, a report message reporting one or more measurement results associated with the U2U relay path. In some embodiments, the report message is transmitted via at least one of: RRC signaling; MAC CE; and L1 signaling. In some embodiments, a measurement is performed by the first UE according to one of: per destination UE, per neighbor UE, per hop, per service, per radio bearer, per Logical Channel (LCH), and per LCH group. In some embodiments, a report message is triggered periodically and/or by at least one of: a trigger event; and upon reception of a request message from the network node for requesting a measurement report. In some embodiments, the U2U relay path is measured by the first UE in terms of one or more E2E metrics comprising at least one of: an E2E bit rate; an E2E packet delay; and an E2E packet error rate. In some embodiments, an E2E packet delay is measured at the Packet Data Convergence Protocol (PDCP) layer. In some embodiments, an E2E metric is determined based on at least per-hop measurement results along the U2U relay path. In some embodiments, the E2E metric is determined as: a sum of the per-hop measurement results along the U2U relay path; an average of the per-hop measurement results along the U2U relay path; a maximum of the per-hop measurement results along the U2U relay path; a minimum of the per-hop measurement results along the U2U relay path; and an output of a mathematic function, which has the per-hop measurement results along the U2U relay path as inputs.

In some embodiments, the method further comprises: declaring a Radio Link Failure (RLF) event for the U2U relay path in response to determining an RLF event on any hop of the U2U relay path. In some embodiments, the step of determining an RLF event on any hop of the U2U relay path comprises at least one of: detecting an RLF event on a hop between the first UE and its neighbor U2U relay UE along the U2U relay path; and receiving, from another UE, an indication of an RLF event on a hop of the U2U relay path that is not a hop between the first UE and its neighbor U2U relay UE along the U2U relay path. In some embodiments, the step of declaring the RLF event for the U2U relay path comprises: transmitting, to the network node, a message indicating the RLF event. In some embodiments, the RLF event indicates at least one of: a failure cause; the hop where the RLF event is detected; an ID of the first UE; and an ID of the second UE. In some embodiments, after the step of transmitting a report message, the method further comprises: receiving, from the network node, another message indicating at least one of: a configuration to reconfigure the existing U2U relay path; one or more additional U2U relay UE candidates for the first UE to replace one or more existing U2U relay UEs on the U2U relay path; a configuration to reconfigure one or more Radio Bearers (RBs) that are transmitted on the U2U relay path with an RLF event detected to a Uu path without an RLF event detected and to continue the corresponding transmission on the Uu path; an indication to release the U2U relay path; one or more additional resources assigned to the U2U relay path; one or more resource pools different from the one or more resource pools that are currently selected; and one or more carriers different from the one or more carriers that are currently selected.

In some embodiments, the step of communicating with the second UE and/or at least one of the one or more U2U relay UEs comprises: transmitting, to the second UE and/or at least one of the one or more U2U relay UEs, a request message; and receiving, from the second UE and/or the at least one of the one or more U2U relay UEs, a response message indicating whether the request message is accepted or rejected by a network node associated with the second UE and/or at least one of the one or more U2U relay UEs. In some embodiments, the method further comprises at least one of: receiving, from the second UE and/or at least one of the one or more U2U relay UEs, a report message via a sidelink connection; receiving, from the second UE and/or at least one of the one or more U2U relay UEs, a message indicating that the U2U relay path needs to be reconfigured; receiving, from the second UE and/or at least one of the one or more U2U relay UEs, a message indicating that one or more U2U relay UEs on the U2U relay path needs to be reselected; receiving, from the second UE and/or at least one of the one or more U2U relay UEs, a message indicating that the U2U relay path needs to be released; and receiving, from the second UE and/or at least one of the one or more U2U relay UEs, a message indicating that one or more specific RBs need to be remapped to a Uu path.

In some embodiments, the method further comprises at least one of: receiving, from the network node, a message indicating that the U2U relay path needs to be reconfigured; receiving, from the network node, a message indicating that one or more U2U relay UEs on the U2U relay path needs to be reselected; receiving, from the network node, a message indicating that the U2U relay path needs to be released; and receiving, from the network node, a message indicating that one or more specific RBs need to be remapped to a Uu path.

According to a second aspect of the present disclosure, a first UE is provided. The first UE comprises: a processor; a memory storing instructions which, when executed by the processor, cause the processor to perform any of the methods of the first aspect.

According to a third aspect of the present disclosure, a first UE for performing a U2U communication with a second UE via one or more U2U relay UEs is provided. The first UE comprises: a receiving module configured to receive, from a network node, a message indicating control information for the U2U communication; and a communicating module configured to communicate with the second UE and/or at least one of the one or more U2U relay UEs for the U2U communication based on at least the indicated control information. In some embodiments, the first UE may comprise one or more further modules, each of which may perform any of the methods of the first aspect.

According to a fourth aspect of the present disclosure, a method at a network node for facilitating a first UE in performing a U2U communication with a second UE via one or more U2U relay UEs is provided. The method comprises: transmitting, to the first UE, a message indicating control information for the U2U communication.

In some embodiments, the message comprises at least one of: system information that carries cell specific configuration applicable to all UEs in a cell; a paging message that carries control information for one or more UEs that are paged; an RRC message that carries UE specific control information and/or cell specific control information; a Control PDU of a protocol layer; a MAC CE; and L1 signaling. In some embodiments, the control information indicates one or more U2U relay UE candidates via which the first UE shall set up a U2U relay path to the second UE. In some embodiments, the control information further indicates at least one of: one or more traffic types or services that shall be transmitted via a U2U relay UE; one or more IDs of the one or more U2U relay UE candidates; an indicator indicating whether a U2U relay UE that is not indicated by the control information can be selected by the first UE or not; an L2 configuration to be set up at the first UE based on a number of hops; a priority order of the one or more U2U relay UE candidates; a timer value indicating a maximum time period during which the first UE needs to provide a response message to the network node during a U2U relay path establishment procedure; a maximum number of the one or more U2U relay UE candidates that can be tried; and a maximum number of U2U relay UEs that are not indicated by the control information and that can be tried.

In some embodiments, data associated with a traffic type or a service that is not indicated by the control information is transmitted by the first UE over a Uu path while data associated with a traffic type or a service that is indicated by the control information is transmitted by the first UE over a U2U relay path. In some embodiments, the control information indicates that data associated with a traffic type or a service is to be transmitted by the first UE over a U2U path, a U2N path, or a Uu path. In some embodiments, an ID of a U2U relay UE candidate comprises at least one of: an SL ID to identify a corresponding U2U relay UE candidate; a Uu ID to identify a corresponding U2U relay UE candidate; and a temporary ID assigned to a corresponding U2U relay UE candidate. In some embodiments, the L2 configuration indicated by the control information is applied by the first UE during a U2U relay path establishment procedure.

In some embodiments, when the priority order of the one or more U2U relay UE candidates is indicated by the control information, a U2U relay path establishment procedure is attempted by the first UE towards each of the one or more U2U relay UE candidates in the indicated priority order. In some embodiments, the priority order is determined based on at least one of: one or more measurements between any two of the first UE, the second UE, and the one or more U2U relay UE candidates that have a direct link therebetween; and a load status at each of the one or more U2U relay UE candidates. In some embodiments, when a common timer value for all U2U relay UE candidates is indicated by the control information, the first UE is expected to stop trying to establish a U2U relay path to the second UE via any U2U relay UE candidate when a timer started with the common timer value is expired. In some embodiments, when one or more other timer values, which are associated with one or more U2U relay UE candidates, respectively, are indicated by the control information, for each of the one or more other timer values, the first UE is expected to stop trying to establish a U2U relay path to the second UE via an associated U2U relay UE candidate when another timer started with the corresponding other timer value is expired. In some embodiments, when separate timer values, which are associated with the U2U relay UE candidates, respectively, are indicated by the control information, for each of the separate timer values, the first UE is expected to stop trying to establish a U2U relay path to the second UE via an associated U2U relay UE candidate when a timer started with the corresponding separate timer value is expired.

In some embodiments, the method further comprises: receiving, from the first UE, a failure event together with an identifier of an associated U2U relay UE candidate. In some embodiments, when the control information indicates an L2 configuration to be set up at the first UE, the L2 configuration indicates at least one of: a number of hops involved; one or more measurements between any two of the first UE, the second UE, and the one or more U2U relay UE candidates that have a direct link therebetween; and an E2E PDB required to support a service; and an E2E PER required to support a service. In some embodiments, when the control information indicates only one U2U relay UE candidate, the method further comprises: transmitting, to the first UE, a message indicating at least one of: another control information indicating another U2U relay UE candidate; that the first UE is to select another U2U relay UE candidate by itself; and that the first UE is to abort the U2U relay path establishment procedure. In some embodiments, when the control information indicates multiple U2U relay UE candidates, whether a U2U relay path establishment procedure is performed towards one U2U relay UE candidate at a time or towards multiple U2U relay UE candidates at the same time is up to the first UE to determine. In some embodiments, a failure event is reported by the first UE to the network node via at least one of: RRC signaling; MAC CE; and L1 signaling. In some embodiments, the failure event indicates at least one of: a failure cause; an ID of the first UE; one or more U2U relay UE candidates to which one or more U2U relay path establishment procedures were attempted since the last failure event was reported; and whether the first UE is allowed to try additional U2U relay UE candidates.

In some embodiments, the method further comprises: receiving, from the first UE, a report message reporting one or more measurement results associated with a U2U relay path. In some embodiments, the report message is transmitted via at least one of: RRC signaling; MAC CE; and L1 signaling. In some embodiments, a measurement is performed by the first UE according to one of: per destination UE, per neighbor UE, per hop, per service, per radio bearer, per LCH, and per LCH group. In some embodiments, a report message is triggered periodically and/or by at least one of: a trigger event; and upon reception of a request message from the network node for requesting a measurement report. In some embodiments, the U2U relay path is measured by the first UE in terms of one or more E2E metrics comprising at least one of: an E2E bit rate; an E2E packet delay; and an E2E packet error rate. In some embodiments, an E2E packet delay is measured at the PDCP layer. In some embodiments, an E2E metric is determined based on at least per-hop measurement results along the U2U relay path. In some embodiments, the E2E metric is determined as: a sum of the per-hop measurement results along the U2U relay path; an average of the per-hop measurement results along the U2U relay path; a maximum of the per-hop measurement results along the U2U relay path; a minimum of the per-hop measurement results along the U2U relay path; and an output of a mathematic function, which has the per-hop measurement results along the U2U relay path as inputs.

In some embodiments, the method further comprises: receiving, from the first UE, a message indicating an RLF event on the U2U relay path. In some embodiments, the RLF event indicates at least one of: a failure cause; the hop where the RLF event is detected; an ID of the first UE; and an ID of the second UE. In some embodiments, after the step of receiving a report message, the method further comprises at least one of: reconfiguring the existing U2U relay path; signaling one or more additional U2U relay UE candidates for the first UE to replace one or more existing U2U relay UEs on the U2U relay path; reconfiguring one or more RBs that are transmitted on the U2U relay path with an RLF event detected to a Uu path without an RLF event detected and continuing the corresponding transmission on the Uu path; releasing the U2U relay path; assigning one or more additional resources to the U2U relay path; selecting one or more resource pools different from the one or more resource pools that are currently selected; and selecting one or more carriers different from the one or more carriers that are currently selected. In some embodiments, the step of reconfiguring the existing U2U relay path comprises at least one of: reconfiguring one or more mappings from one or more RBs to RLC channels on each hop; and reconfiguring QoS split among hops for one or more RBs.

In some embodiments, the method further comprises at least one of: receiving, from another network node, a message indicating that the U2U relay path needs to be reconfigured, and transmitting, to the first UE, a message indicating that the U2U relay path needs to be reconfigured; receiving, from another network node, a message indicating that one or more U2U relay UEs on the U2U relay path needs to be reselected, and transmitting, to the first UE, a message indicating that one or more U2U relay UEs on the U2U relay path needs to be reselected; receiving, from another network node, a message indicating that the U2U relay path needs to be released, and transmitting, to the first UE, a message indicating that the U2U relay path needs to be released; and receiving, from another network node, a message indicating that one or more specific RBs need to be remapped to a Uu path, and transmitting, to the first UE, a message indicating that one or more specific RBs need to be remapped to a Uu path.

According to a fifth aspect of the present disclosure, a network node is provided. The network node comprises: a processor; a memory storing instructions which, when executed by the processor, cause the processor to perform any of the methods of the fourth aspect.

According to a sixth aspect of the present disclosure, a network node for facilitating a first UE in performing a U2U communication with a second UE via one or more U2U relay UEs is provided. The network node comprises: a transmitting module configured to transmit, to the first UE, a message indicating control information for the U2U communication. In some embodiments, the network node may comprise one or more further modules, each of which may perform any of the methods of the fourth aspect.

According to a seventh aspect of the present disclosure, a method at a UE for facilitating a first UE in performing a U2U communication with a second UE via one or more U2U relay UEs is provided. The method comprises: receiving, from the first UE, a discovery message or a link establishment request message; and communicating with the first UE for the U2U communication based on at least the discovery message or the link establishment request message, wherein the discovery message or the link establishment request message indicates at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not.

In some embodiments, the UE is the second UE or one of the U2U relay UEs. In some embodiments, when a U2U relay path is successfully established between the first UE and the second UE via at least one U2U relay UE, the method further comprises: monitoring and/or measuring the U2U relay path. In some embodiments, the U2U relay path is monitored and/or measured in terms of at least one of: one or more radio channel quality metrics on any hop between any two of the first UE, the second UE, and the at least one U2U relay UE that have a direct link therebetween; a transmission failure rate; a retransmission ratio; one or more QoS metrics; and one or more congestion metrics. In some embodiments, at least one of following is true: a radio channel quality metric comprises at least one of RSRP, RSRQ, RSSI, SINR, SIR, and BLER; a transmission failure rate comprises at least one of a HARQ failure rate and a RLC PDU failure rate; a retransmission ratio comprises at least one of a HARQ retransmission ratio and an RLC PDU retransmission ratio; a QoS metric comprises at least one of a bit rate, a packet delay, and a packet error rate; and a congestion metric comprises at least one of a CBR, a CR, a channel occupancy in case of unlicensed operation, an LBT success/failure ratio in case of unlicensed operation.

In some embodiments, the method further comprises: transmitting, to a network node, a report message reporting one or more measurement results associated with the U2U relay path. In some embodiments, the report message is transmitted via at least one of: RRC signaling; MAC CE; and L1 signaling. In some embodiments, a measurement is performed by the UE according to one of: per destination UE, per neighbor UE, per hop, per service, per radio bearer, per LCH, and per LCH group. In some embodiments, a report message is triggered periodically and/or by at least one of: a trigger event; and upon reception of a request message from the network node for requesting a measurement report. In some embodiments, the step of communicating with the first UE comprises: forwarding, from the first UE to a network node associated with the UE, a request message; and forwarding, from the network node to the first UE, a response message indicating whether the request message is accepted or rejected by the network node. In some embodiments, the step of communicating with the first UE comprises at least one of: transmitting, to the first UE, a report message via a sidelink connection; transmitting, to the first UE, a message indicating that the U2U relay path needs to be reconfigured; transmitting, to the first UE, a message indicating that one or more U2U relay UEs on the U2U relay path needs to be reselected; transmitting, to the first UE, a message indicating that the U2U relay path needs to be released; and transmitting, to the first UE, a message indicating that one or more specific RBs need to be remapped to a Uu path.

According to an eighth aspect of the present disclosure, a UE is provided. The UE comprises: a processor; a memory storing instructions which, when executed by the processor, cause the processor to perform any of the methods of the seventh aspect.

According to a ninth aspect of the present disclosure, a UE for facilitating a first UE in performing a U2U communication with a second UE via one or more U2U relay UEs is provided. The UE comprises: a receiving module configured to receive, from the first UE, a discovery message or a link establishment request message; and a communicating module configured to communicate with the first UE for the U2U communication based on at least the discovery message or the link establishment request message. In some embodiments, the discovery message or the link establishment request message indicates at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not. In some embodiments, the UE is the second UE or one of the one or more U2U relay UEs. In some embodiments, the UE may comprise one or more further modules, each of which may perform any of the methods of the seventh aspect.

According to a tenth aspect of the present disclosure, a computer program comprising instructions is provided. The instructions, when executed by at least one processor, cause the at least one processor to carry out the method of any of the first, fourth, and seventh aspects.

According to an eleventh aspect of the present disclosure, a carrier containing the computer program of the tenth aspect is provided. In some embodiments, the carrier is one of an electronic signal, optical signal, radio signal, or computer readable storage medium.

According to a twelfth aspect of the present disclosure, a telecommunications network is provided. The telecommunications network comprises: one or more UEs of claim of the second and/or third aspects; one or more UEs of the eighth and/or ninth aspects; and at least one network node of the fifth and/or sixth aspects.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunications network in which network controlled U2U relay link maintenance may be applicable according to an embodiment of the present disclosure.

FIG. 2 is a diagram illustrating exemplary User Plane (UP) and Control Plane (CP) protocol stacks for an architecture model using a layer 2 (L2) U2U relay with which network controlled U2U relay link maintenance may be applicable according to an embodiment of the present disclosure.

FIG. 3 is a diagram illustrating exemplary U2U relay discovery procedures with which network controlled U2U relay link maintenance may be applicable according to an embodiment of the present disclosure.

FIG. 4 is a diagram illustrating an exemplary L2 U2U relay connection establishment procedure with which network controlled U2U relay link maintenance may be applicable according to an embodiment of the present disclosure.

FIG. 5 is a flow chart illustrating an exemplary method at a first UE for performing a U2U communication with a second UE via one or more U2U relay UEs according to an embodiment of the present disclosure.

FIG. 6 is a flow chart illustrating an exemplary method at a network node for facilitating a first UE in performing a U2U communication with a second UE via one or more U2U relay UEs according to an embodiment of the present disclosure.

FIG. 7 is a flow chart illustrating an exemplary method at a UE for facilitating a first UE in performing a U2U communication with a second UE via one or more U2U relay UEs according to an embodiment of the present disclosure.

FIG. 8 schematically shows an embodiment of an arrangement which may be used in UEs and/or a network node according to an embodiment of the present disclosure.

FIG. 9 is a block diagram of an exemplary UE according to an embodiment of the present disclosure.

FIG. 10 is a block diagram of an exemplary network node according to an embodiment of the present disclosure.

FIG. 11 is a block diagram of another exemplary UE according to another embodiment of the present disclosure.

FIG. 12 shows an example of a communication system in accordance with some embodiments of the present disclosure.

FIG. 13 shows an exemplary UE in accordance with some embodiments of the present disclosure.

FIG. 14 shows an exemplary network node in accordance with some embodiments of the present disclosure.

FIG. 15 is a block diagram of an exemplary host, which may be an embodiment of the host of FIG. 12, in accordance with various aspects described herein.

FIG. 16 is a block diagram illustrating an exemplary virtualization environment in which functions implemented by some embodiments may be virtualized.

FIG. 17 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5th Generation New Radio (5G NR), the present disclosure is not limited thereto. In fact, as long as network controlled U2U relay link maintenance is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, a network node, an access network (AN) node, or any other equivalents. Further, the term “node” used herein may refer to a UE, a functional entity, a network entity, a network element, a network equipment, or any other equivalents.

Further, the following 3GPP document is incorporated herein by reference in its entirety:
3GPP TR 23.700-33 V0.3.0 (May 2022), Technical Report, 3rd Generation Partnership Project; Technical Specification Group Services and System Aspects; Study on system enhancement for Proximity based Services (ProSe) in the 5G System (5GS); Phase 2 (Release 18).

NR sidelink communication was specified by 3GPP in Rel-16. The NR SL is an evolution of the LTE sidelink, in particular of the features introduced in Rel-14 and Rel-15 for Vehicle-to-Anything (V2X) communication. Some of the most relevant features of the NR sidelink are the following:
Support for unicast and groupcast transmissions, in addition to broadcast transmissions, which were already supported in LTE.
Support for HARQ feedback over the SL for unicast and groupcast. This feedback is conveyed by the receiver UE to the transmitted UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is critical for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus the QoS management is supported in NR sidelink transmissions.

In NR sidelink, the following physical layer (PHY) channels are defined:
PSCCH (Physical Sidelink Control Channel): This channel carries sidelink control information (SCI) including part of the scheduling assignment (SA) that allows a receiver to further process and decode the corresponding PSSCH (e.g., demodulation reference signal (DMRS) pattern and antenna port, Modulation and Coding Scheme (MCS), etc.). In addition, the PSCCH indicates future reserved resources. This allows a receiver (RX) to sense and predict the utilization of the channel in the future. This sensing information is used for the purpose of UE-autonomous resource allocation (Mode 2), which is described below.
PSSCH (Physical Sidelink Shared Channel): The PSSCH is transmitted by a sidelink transmitter UE, which conveys sidelink transmission data (i.e., the SL shared channel SL-SCH), and a part of the sidelink control information (SCI). In addition, higher layer control information may be carried using the PSSCH (e.g., MAC CES, RRC signaling, etc.). For example, channel state information (CSI) is carried in the medium access control (MAC) control element (CE) over the PSSCH instead of the PSFCH.
PSFCH (Physical Sidelink feedback channel): The PSFCH is transmitted by a sidelink receiver UE for unicast and groupcast. It conveys the SL HARQ acknowledgement, which may consist of ACK/NACK (used for unicast and groupcast option 2) or NACK-only (used for groupcast option 1).
Physical Sidelink Broadcast Channel (PSBCH): The PSBCH conveys information related to synchronization, such as the direct frame number (DFN), indication of the slot and symbol level time resources for sidelink transmissions, in-coverage indicator, etc. The SSB is transmitted periodically at every 160 ms. The PSBCH is transmitted along with the S-PSS/S-SSS as a sidelink synchronization signal block (S-SSB).
Sidelink Primary/Secondary Synchronization Signal (S-PSS/S-SSS) are used by UEs to establish a common timing reference among UEs in the absence of another reference such as Global Navigation Satellite System (GNSS) time or Network (NW) time.

Along with the different physical channels, reference signals (RS) are transmitted for different purposes, including demodulation (DM-RS), phase tracking RS (PT-RS), or RS for channel state information acquisition (CSI-RS).

Another new feature is the two-stage sidelink control information (SCI). A first part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (second stage) of the SCI carries the remaining scheduling and control information such as a 8-bits source identity (ID) and a 16-bits destination ID, New Data Indicator (NDI), Redundant Version (RV) and HARQ process ID is sent on the PSSCH to be decoded by the receiver UE.

NR sidelink supports the following two modes of resource allocation:
Mode 1: Sidelink resources are scheduled by a gNB.
Mode 2: The UE autonomously selects sidelink resources from a (pre-) configured sidelink resource pool. To avoid collisions between UEs, a procedure based on the channel sensing and resource reservation is used.

An in-coverage UE can be configured by a gNB to use Mode 1 or Mode 2. For an out-of-coverage UE, only Mode 2 can be used.

Like in LTE, scheduling over the sidelink in NR is done in different ways for Mode 1 and Mode 2.

In Mode 1, the grant is provided by the gNB. The following two kinds of grants are supported:
Dynamic grants are provided for one or multiple transmissions of a single packet (i.e., transport block). When the traffic to be sent over sidelink arrives at a transmitter UE (i.e., at the corresponding transmitter (TX) buffer), the UE initiates the four-message exchange procedure to request sidelink resources from a gNB (Scheduling Request (SR) on UL, grant, Buffer Status Report (BSR) on UL, grant for data on SL sent to UE). A gNB indicates the resource allocation for the PSCCH and the PSSCH in the downlink control information (DCI) conveyed by PDCCH with CRC scrambled with the SL-RNTI of the corresponding UE. A UE receiving such a DCI, assumes that it has been provided a SL dynamic grant only if it detects that the CRC of DCI has been scrambled with its SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. This kind of grant is also known as grant-free transmissions.

Note that only the transmitter UE is scheduled by the gNB. The receiver UE does not receive any information directly from the gNB. Instead, it is scheduled by the transmitter UE by means of the SCI. Therefore, a receiver UE should perform blind decoding to identify the presence of PSCCH and find the resources for the PSSCH through the SCI.

In Mode 2 resource allocation, the grant is generated by the UE itself. When traffic arrives at a transmitter UE (i.e., at the corresponding TX buffer), this transmitter autonomously selects resources for the PSCCH and the PSSCH. To further enhance the probability of successful Transport Block (TB) decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for:
1) The PSCCH/PSSCH corresponding to the first transmission.
2) The PSCCH/PSCCH corresponding to the retransmissions. Resources for up to 2 retransmissions may be reserved. These reserved resources are always used in case of blind retransmissions. If SL HARQ feedback is used, the use of the reserved resources is conditional on a negative SL HARQ acknowledgement.

Since each transmitter UE in sidelink transmissions should autonomously select resources for its own transmissions, preventing the different transmitter UEs from selecting the same resources turns out to be a critical issue in Mode 2. A particular resource selection procedure is therefore imposed to Mode 2 based on channel sensing. The channel sensing algorithm involves detecting the reservations transmitted by other UEs and performing power measurements (i.e., reference signal received power or RSRP) on the incoming transmissions.

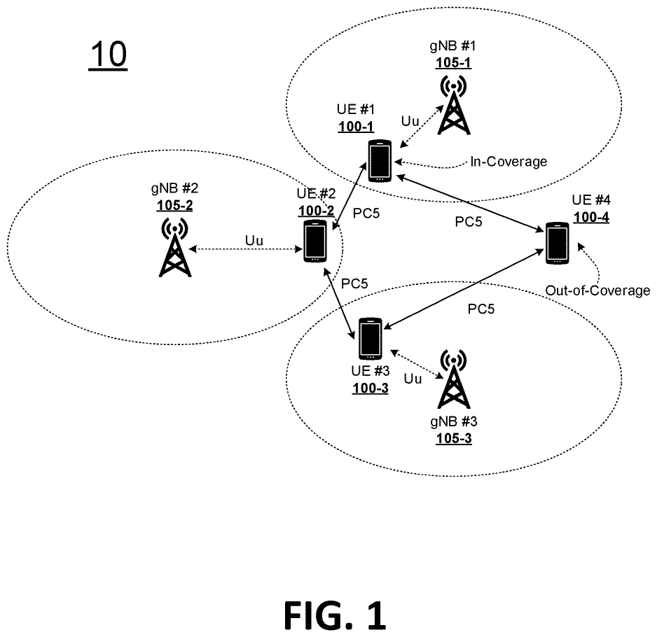

FIG. 1 is a diagram illustrating an exemplary network 10 in which network controlled U2U relay link maintenance may be applicable according to an embodiment of the present disclosure. Although the network 10 is a network defined in the context of 5G NR, the present disclosure is not limited thereto.

As shown in FIG. 1, the network 10 may comprise one or more UEs 100-1 through 100-4 (collectively, UE(s) 100) and optionally one or more Radio Access Network (RAN) nodes 105-1 through 105-3, each of which could be a base station, a Node B, an evolved NodeB (eNB), a gNB, or an AN node which provides the UE #1 100-1 through the UE #3 100-3 with access to the network 10. Further, the network 10 may comprise other nodes and/or entities that are not shown in FIG. 1, for example (but not limited to) an Access & Mobility Management Function (AMF), a Session Management Function (SMF), a Policy Control Function (PCF), and/or a User Plane Function (UPF). Further, as shown in FIG. 1, the UEs 100 may communicate with each other via sidelinks over the reference point PC5, and at least one of the UE 100-1, the UE 100-2, and the UE 100-3 may communicate with a respective one of the gNBs 105, over the reference point Uu. As also shown in FIG. 1, the UE 100-1, the UE 100-2, and the UE 100-3 may be located in the coverage of the gNBs 105 and served by the gNBs 105, while the UE 100-4 may be out of coverage of any of the gNBs 105 and not served by any of the gNB 105.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure. For example, in some embodiments, there is no gNB or there are one or more gNBs that serve some or all of the UEs 100, respectively.

In some embodiments, the UEs 100 may be U2U relay UEs. For example, the UE 100-1 may communicate with the UE 100-3 via the UE 100-2 and/or the UE 100-4 with or without any of the gNBs 105 involved. In such a case, the UE 100-2 and/or the UE 100-4 may be referred to as U2U relay UEs. In some embodiments, the UEs 100 may be U2N relay UEs. For example, the UE 100-4 may communicate with the gNB 105-1 via the UE 100-1 even if the UE 100-4 is located outside of the coverage of the gNB 105-1. In such a case, the UE 100-1 may be referred to as a U2N relay UE. In some embodiments, a relay path is not limited to two hops as described in the above embodiments. For example, the UE 100-1 may communicate with the UE 100-4 via the UE 100-2 and the UE 100-3, and in such a case, both of the UE 100-2 and the UE 100-3 are referred to as U2U relay UEs.

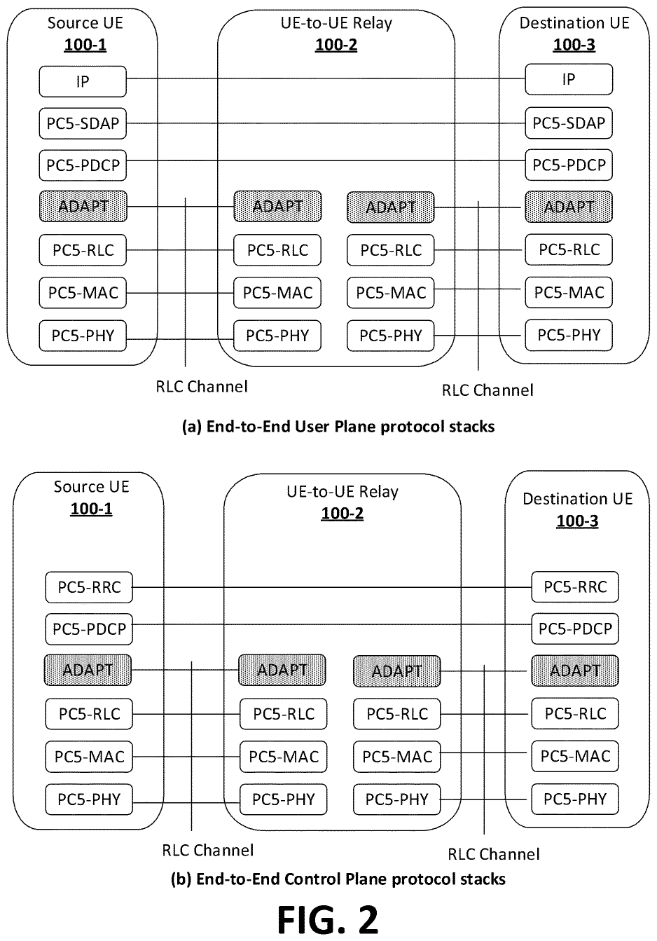

As described in clause A.2 of 3GPP TR 23.700-33 V0.3.0, protocol stacks of L2 U2U relay will be described as the below. FIG. 2 is a diagram illustrating exemplary UP and CP protocol stacks for an architecture model using an L2 U2U relay with which network controlled U2U relay link maintenance may be applicable according to an embodiment of the present disclosure.

As shown in (a) of FIG. 2, which illustrates user plane protocol stacks using an L2 U2U relay 100-2, the security may be established end-to-end between a source UE 100-1 and a destination UE (or a target UE) 100-3. Therefore, user data is never exposed at the relay node (i.e., the U2U relay 100-2) since the relay function does not process/apply any security on the relayed packets. In some embodiments, both IP traffic and Non-IP traffic are supported. Further, the Service Data Adaptation Protocol (SDAP) and PDCP protocols above are as specified in TS 38.300 v17.0.0.

As shown in (b) of FIG. 2, which illustrates control plane protocol stacks using an L2 U2U Relay 100-2, the security may be established end-to-end between the source UE 100-1 and the destination UE 100-3 as shown by the PDCP layer terminating in the source UE 100-1 and the destination UE 100-3. Therefore, the E2E PC5-S message between the source UE 100-1 and the destination UE 100-3 is never exposed at the relay node 100-2 since the relay function does not process/apply any security on the relayed E2E PC5-S messages.

Please note that the definition and functionalities of the Adaptation Layer are defined by RAN WG2.

Please note that only the End-to-End control plane protocol stack is shown in (b) of FIG. 2. The control plane protocol stack of the unicast link between the source UE 100-1/the destination UE 100-3 and the UE-to-UE Relay 100-2 (i.e. PC5 unicast link) can re-use the regular PC5-S protocol stack defined in clause 6.1.2 of 3GPP TS 23.304 v17.2.1.

Please note that PC5-S messages for direct PC5 unicast link with the UE-to-UE Relay and for E2E PC5 unicast link are supported. The E2E PC5-S message is the message transferred between the source UE 100-1 and the destination UE 100-3, and the direct PC5-S message is the message transferred between the source UE 100-1 and the UE-to-UE Relay 100-2 or between the UE-to-UE Relay 100-2 and the destination UE 100-3. How to differentiate them depends on RAN solution. Whether the same pair of source and destination Layer-2 IDs is used for direct and E2E PC5-S messages is to be determined during SA WG2's normative phase and its feasibility is to be confirmed by RAN WG2.

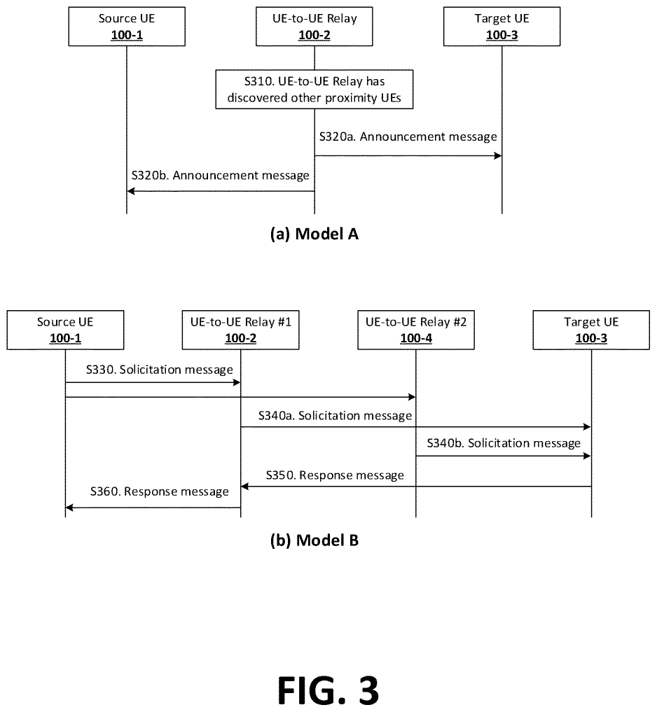

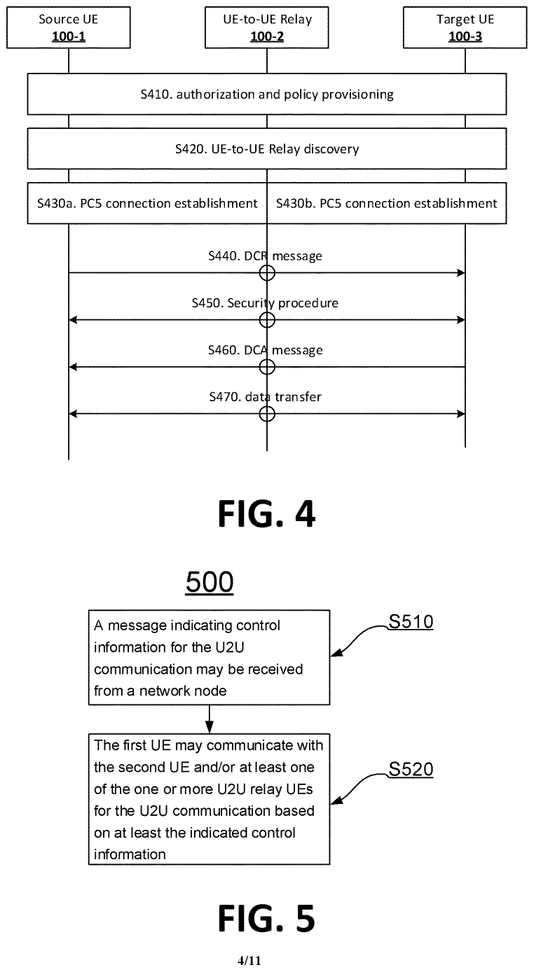

As described in clause 6.30 of 3GPP TR 23.700-33 V0.3.0, different control procedures are described as the below with reference to FIG. 3 and FIG. 4.

Procedure for UE-to-UE Relay Discovery with Model A

Depicted in (a) of FIG. 3 is the procedure for UE-to-UE Relay discovery with Model A.

At step S310, the UE-to-UE Relay 100-2 may have discovered other UEs in proximity via the direct discovery or direct communication procedures.

At steps S320a and S320b (or actually a single step S320), the UE-to-UE Relay 100-2 may send an Announcement message. The Announcement message may include the Type of Discovery Message, User Info ID of the UE-to-UE Relay 100-2, Relay Service Code (RSC), and User Info ID of the proximity UEs. In some embodiments, the Source Layer-2 ID of the Announcement message is self-assigned by the UE-to-UE Relay 100-2, and the Destination Layer-2 ID is selected based on the ProSe policy.

Depicted in (b) of FIG. 3 is the procedure for UE-to-UE Relay discovery with Model B.

At step S330, the Source UE 100-1 may broadcast a Solicitation message. The Solicitation message may include the Type of Discovery Message, User Info ID of Source UE 100-1, User Info ID of Target UE 100-3, and RSC. In some embodiments, the Source Layer-2 ID of the Announcement message is self-assigned by the Source UE 100-1, and the Destination Layer-2 ID is selected based on the ProSe policy.

At steps S340a and S340b (or collectively, S340), on reception of the Solicitation message, a candidate UE-to-UE Relay (e.g., UE-to-UE Relay #1 100-2 and UE-to-UE Relay #2 100-4) may broadcast a Solicitation message carrying the User Info ID of Source UE 100-1, User Info ID of Target UE 100-3, User Info ID of the UE-to-UE Relay 100-2/100-4, and the RSC. In some embodiments, the Source Layer-2 ID of the Announcement message is self-assigned by the candidate UE-to-UE Relay, and the Destination Layer-2 ID is selected based on the ProSe policy.

At step S350, the Target UE 100-3 may choose UE-to-UE Relay #1 100-2 from the candidate UE-to-UE Relays based on, e.g. signal strength. The Target UE 100-3 may respond to UE-to-UE Relay #1 100-2.

At step S360, the UE-to-UE Relay #1 100-2 may respond to the Source UE 100-1.

Depicted in FIG. 4 is the procedure for Layer-2 UE-to-UE Relay connection establishment.

At step S410, service authorization and policy provisioning may be performed for the Source UE 100-1, Target UE (or the destination UE) 100-3, and UE-to-UE Relay 100-2 as described in the solutions for KI #6 in 3GPP TR 23.700-33 V0.3.0.

At step S420, the UE-to-UE Relay discovery may be performed as described with reference to FIG. 3 or in clause 6.30.2.1 of TR 23.700-33 V0.3.0.

At step S430 (i.e. the step S430a and/or the step S430b), the Source UE 100-1 and the Target UE 100-3 may need to setup or modify the PC5 link with UE-to-UE Relay 100-2.

If there is no PC5 link between the Source UE 100-1 and the UE-to-UE Relay 100-2 that can be used for relaying, e.g. based on RSC, then a new PC5 link needs to be setup in step S430a by the Source UE 100-1, otherwise the existing link can be modified by the Source UE 100-1 to support communication between the Source and Target UEs 100-1 and 100-3. User Info ID of Target UE 100-3 may be included in the Direct Communication Request message or Link Modification Request message. The Target User Info for the Target UE 100-3 may be obtained from the discovery procedure performed in step S420.

If there is no PC5 link between the UE-to-UE Relay 100-2 and the Target UE 100-3 that can be used for relaying, e.g. based on RSC, then a new PC5 link needs to be setup in step 430b by the UE-to-UE Relay 100-2, otherwise the existing link can be modified by the UE-to-UE Relay 100-2 to support communication between the Source and Target UEs 100-1 and 100-3.

If a new PC5 link needs to be setup in either step 430a or step 430b the destination Layer-2 ID may be broadcast or unicast Layer-2 ID and the Source Layer-2 ID is self-assigned by the Source UE 100-1 or the UE-to-UE Relay 100-2. When a unicast destination Layer-2 ID is used, it is obtained during the discovery procedure performed in step S420.

Please note that RAN coordination on support of per-hop PC5 link sharing between the Source UE 100-1 and UE-to-UE Relay 100-2, and UE-to-UE Relay 100-2 and Target UE 100-3 may be needed.

At step S440, the Source UE 100-1 may send a Direct Communication Request (DCR) message to initiate the unicast Layer-2 link establishment procedure with the Target UE 100-3. The Direct Communication Request message may include User Info ID of Source UE 100-1, User Info ID of Target UE 100-3, QoS Info (PFI and PC5 QoS parameters) and RSC.

The Direct Communication Request message may be sent over the PC5 link with the UE-to-UE Relay 100-2. The Source Layer-2 ID and the Destination Layer-2 ID of the PC5 link setup or modified in step S430a may be used.

The UE-to-UE Relay 100-2 may forward the Direct Communication Request message towards the Target UE 100-3, and the Direct Communication Request message may be sent over the PC5 link with the Target UE 100-3. The Source Layer-2 ID and the Destination Layer-2 ID of the PC5 link setup or modified in step S430b may be used.

At step S450, the Target UE 100-3 may trigger the security procedure with Source UE 100-1.

At step 460, the Target UE 100-3 may send a Direct Communication Accept (DCA) message to the Source UE 100-1. The Direct Communication Accept message may include User Info ID of Source UE 100-1, User Info ID of Target UE 100-3, QoS Info (PFI and PC5 QoS parameters) and RSC.

Please note that RAN WGs will define how the E2E QoS will be handled and split over the PC5 links.

At step S470, the end-to-end QoS flow may be established between Source UE 100-1 and Target UE 100-3. The data may be transferred between the Source UE 100-1 and the Target UE 100-3 via the UE-to-UE Relay 100-2.

Please note that how the PC5-S messages in steps S440 through S460 and the data in step S470 are forwarded by the UE-to-UE Relay 102 is to be determined by RAN2, such as based on an Adaptation layer.

SL U2U relay is one of the topics being studied in 3GPP Rel-18.

RAN2 has started discussion for SL U2U relay in RAN2 #119-e, and made the following agreements:

RAN2 confirm that the Scenario, Assumption and Requirement in section
5.1 of TR 38.836 apply for UE-to-UE relay support, with below
clarifications:

| | |
|---|---|
| - | For cast type on UE-to-UE communication, only unicast is considered |
| - | FFS if coverage and RRC state aspects need to be revisited in light of |

the existing U2N support.

| | |
|---|---|
| - | RAN2 will follow SA2 decision on the discovery model including cast |

type.

Based on the above agreement, it is possible that U2U relaying can be performed by a UE in any RRC state i.e., RRC_CONN/INACTIVE/IDLE. For sidelink communications in general, when the UE is in INACTIVE/IDLE state, the UE is allowed to operate based on a (pre)configuration or cell-specific broadcast information (for e.g., in SIB) from the gNB. However, when operating in the RRC_CONN state, it was agreed that the gNB can be responsible for providing certain configurations via dedicated RRC signaling. In addition, the configurations in the current specifications do not support U2U relaying and as a result, whether and how the network should be involved in the U2U relaying procedure will be discussed hereinafter.

For a remote UE out of network coverage, it is natural that the UE selects a relay UE by itself. While if the remote UE has network coverage, the gNB serving the remote UE can be involved with the procedure of relay link maintenance, which may comprise the following functions:
1) Relay path establishment;
2) Relay path monitoring;
3) Relay path failure handling.

The existing control procedures for U2N relay and Uu scenarios cannot be directly reused for U2U relay where the UE has coverage due to the below reasons:
1) The procedures for Uu are applicable only to one hop involving only the gNB and the UE. However a U2U relay path comprises at least two hops involving multiple UEs and multiple gNBs.
2) The procedures for U2N relay are involving multiple UEs and only one gNB, since UEs are served by the same gNB. However, a U2U relay path comprises at least two hops involving multiple UEs and multiple gNBs.
3) for U2N relay gNB has a full control on link maintenance as the communication will finally go through the gNB and gNB knows the performance of both Uu hop and SL hop. This is not feasible/required for U2U relay as the gNB is not involved in the actual communication and may only know the performance of the first hop of a U2U relay path.
4) for U2N relay the remote UE cannot inform the gNB of RLF detected on the relay path thus the gNB cannot be involved in handling of RLF when RLF is being detected. The remote UE only communicates with the gNB after RLF has been recovered. For U2U relay, the UE can always communicate with gNB over Uu even when RLF is detected.

Therefore, it is necessary to study how to involve gNB control in the above procedure in case of U2U relay.

In some embodiments of the present disclosure, various gNB involved control procedures regarding how a U2U relay path is maintained are designed. The designed procedures focus on U2U relay particular aspects comprising (but not limited to):
1) U2U relay specific signaling information and content in the message;
2) UE behaviors on how to select/reselect U2U relay UE under instruction of the gNB;
3) UE behaviors on U2U relay path monitoring and RLF handling under instruction of the gNB;
4) Behaviors of Intermediate UEs and destination remote UE on the relay path upon reception of a signaling from the initiating UE of the relay path;
5) Behaviors of gNBs on a relay path regarding U2U link establishment and maintenance, i.e., there may be multiple gNBs on the relay path.

For a UE involved in a U2U relay path, if the UE has network coverage to a gNB. The UE shall leave the gNB to control the U2U relay path. The proposed procedures have covered various signaling details and UE behaviors in case of U2U relay.

With some embodiments of the present disclosure, at least one of following benefits can be achieved:
1. UE can select a most suitable U2U relay UE to establish a relay path towards a destination UE.
2. Avoid SL transmissions in case of U2U relay creating interference to Uu transmissions.

In some embodiments of the present disclosure a term node is used which can be a network node or a UE. Examples of network nodes are NodeB, base station (BS), multi-standard radio (MSR) radio node such as MSR BS, eNodeB, gNodeB. MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, RRU, RRH, nodes in distributed antenna system (DAS), core network node (e.g. MSC, MME etc.), O&M, OSS, SON, positioning node (e.g. E-SMLC), etc.

In some embodiments, another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU), Remote Radio Head (RRH), Central Unit (e.g. in a gNB), Distributed Unit (e.g. in a gNB), Baseband Unit, Centralized Baseband, C-RAN, access point (AP) etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

The embodiments are described in the context of NR. As an example, the embodiments are described in a relay scenario including a source remote UE (referred to as UE1), a relay UE (referred to as UE2), and a destination remote UE (referred to as UE3). The link between the source remote UE and relay UE, and the link between the relay UE and the destination remote UE may be based on LTE sidelink or NR sidelink, but not limited. Any short-range communication technology such as Wifi is equally applicable. The embodiments are also applicable to the scenario where the source remote UE and destination remote UE are connected via more than one intermediate relay UEs.

The embodiments are also described with the assumption of different coverage levels i.e.,
Partial coverage: Either UE1/UE2/UE3 are under the coverage of a gNB;
Full coverage: All the UEs (UE1 and UE2 and UE3) are under the coverage of a gNB.

The embodiments described herein are applicable to U2U relay comprising two or more than two hops.

### Group A Embodiments—Relay Path Establishment

The embodiments in this group cover the procedures for a source remote UE (e.g., UE1) to establish a U2U relay path to another destination remote UE (e.g., UE3) via a U2U relay UE (e.g., UE2) under the control of the gNB1 under either partial or full coverage and based on coverage. Therefore, gNB1 can send the control information to UE1 instructing UE1 to perform maintenance for a U2U relay path. The control information may be signaled to UE1 via signaling alternatives including at least one of the following and not limited to:
System information (i.e., SIB or MIB), which carries cell specific configuration applicable to all UEs in the cell
Paging message, which carries control information for one or multiple UEs which are paged
RRC signaling (i.e., Uu RRC signaling)
   In an example, which carries UE specific control information
   In an example, which carries cell specific control information, e.g., during handover
Control PDU of a protocol layer (e.g., SDAP, PDCP, RLC or an adaptation layer which is responsible for the relaying functionality)
MAC CE
L1 signaling (carried on the physical channels including PDSCH, PDCCH etc.)

In some embodiments, UE1 may receive a signaling from gNB1 indicating that UE1 shall setup a U2U relay path to UE3 via at least one indicated U2U relay UE (e.g., UE2).

In some embodiments, compared to the existing Uu or U2N signaling, the signaling may comprise at least one of the following additional information:
Traffic types or services that shall be transmitted via a U2U relay UE
   It could happen that UE1 transmits some (types) of services over Uu path and some other (types) of services via U2U relay UE simultaneously.
   gNB1 can dynamically map or remap a service or traffic type to a different U2U relay UE.
   gNB1 can dynamically map or remap a service or traffic type to a U2U relay UE or a Uu path.
   in case U2N relay UEs are available, gNB1 can dynamically map or remap a service or traffic type to a U2U relay UE, a U2N relay UE, or a Uu path.
IDs of one or multiple U2U relay UE candidates
   The ID may be an SL ID to identify the associated U2U relay UE candidate, e.g., L2 ID
   The ID may be an Uu ID to identify the associated U2U relay UE candidate, e.g., RNTI, Resume ID, TMSI, IMSI
   The ID may be a temporary ID assigned (by the gNB) to the associated U2U relay UE candidate
Whether non indicated U2U relays UEs in the signaling can be selected by UE1.
An L2 configuration to be setup at the UEs based on the number of hops i.e., a split QoS configuration in terms of RLC/MAC/PHY configuration across the hops and a mapping configuration between different hops.
A priority order of the U2U relay UE candidates
A timer value indicating a maximum time period during which UE1 needs to provide response message to gNB1 during a U2U relay path establishment procedure. The timer may be service (type) specific.
The maximum number of U2U relay UEs that can be tried. Such number may be service (type) specific.
The maximum number of non-indicated U2U relay UEs (i.e., U2U relay UEs not indicated in the signaling) that can be tried. Such number may be service (type) specific.

In some embodiments, upon reception of the signaling, UE1 may perform at least one of the following actions:
consider the target L2 U2U Relay UE (e.g., UE2) to be the one indicated by the ID of the U2U relay UE candidate in the signalling message.
start the timer for the corresponding target L2 U2U Relay UE (e.g., UE2) with the timer value as included in the signalling message.
perform the establishment procedure to setup the relay path to UE3 via UE2.
   during the establishment procedure, UE1 applies the L2 configuration.
when the timer is running, UE1 stops the timer when UE1 has successfully established the relay path.
When the timer is expired, UE1 declares a failure event e.g., U2U relay path failure.
When the timer is expired, UE1 reselects a different U2U relay UE.
When the timer is expired, UE1 reselects a different U2N relay UE.
When the timer is expired, UE1 reselects a Uu path.

In some embodiments, in case there are multiple U2U relay UE candidates indicated in the signalling message, UE1 may follow a priority order (e.g., following a decreasing order of the priority of each relay UE candidate) to attempt to establish the relay path to UE3 via each relay UE candidate. The priority order can be decided by the gNB and indicated to the UE in the form of a list with the highest priority assigned to the first/last value in the list. The list can be formulated based on:
Measurements in terms of RSRP/SINR/RSRQ between the UE1/UE2 and/or UE2/UE3
UE2's load in terms of number of UEs supported or the number of logical channels remaining.

In some embodiments, as far as UE1 has succeeded to establish the relay path to UE3 via one relay UE candidate, UE1 may stop the establishment procedure and stop the timer. In some embodiments, UE1 may have two options to handle the timer as follows.

Option 1: maintain a common timer for all relay UE candidates.

In other words, UE1 may start the timer when UE1 attempts to setup the relay path to UE3 via the first relay UE candidate. When UE1 switches to a second relay UE candidate if UE1 has failed to establish the relay path via the first relay UE candidate, UE1 may keep the timer running. As far as UE1 has succeeded to establish the relay path to UE3 via one relay UE candidate or UE1 has tried the establishment via all the relay UE candidates that it shall/could try, UE1 may stop the establishment procedure and stop the timer. When the timer is expired or has tried the establishment via all the relay UE candidates that it shall/could try, UE1 may stop the establishment procedure and declare a failure event, i.e., the U2U path cannot be established, and send the event to gNB1.

In some embodiments, in addition, there may be a second timer indicating a maximum time period which allows UE1 to attempt to establish the relay path via a relay UE candidate. The second timer may be set with different values for different relay UE candidates.

Option 2: maintain separate timers for different relay UE candidates. Whenever UE1 switches to a different relay UE candidate, UE1 may start a separate timer with the timer value as included in the signalling message (there may be different timer values signalled for each relay UE candidate in the signalling message). When the timer associated to a relay UE candidate is expired, UE1 may stop the establishment procedure via that relay UE candidate and may declare a failure event, i.e., the U2U path cannot be established via a specific relay UE candidate together with the relay UE ID, and send the event to gNB1.

In some embodiments, UE1 may declare a failure event e.g., U2U relay path failure when one of the following occurs:
the common timer for all relay UE candidates has expired, UE1 has not completed the establishment procedure to setup the relay path to UE3.
UE1 cannot complete the establishment procedure to setup the relay path to UE3 via any relay UE candidate indicated in the signalling message.

In some embodiments, gNB1 can configure UE1 with the split QoS configuration across the different links in terms of the Layer-2 configuration of RLC/MAC/PHY channels based on the following information provided to the gNB:
Number of hops involved
Measurements between the different UE's in terms of RSRP/RSRQ/SINR
E2E packet delay budget required to support a service
E2E packet error rate required to support a service

In some embodiments, each time the gNB may only inform (at most) one U2U relay UE candidate to UE1, if it received a failure event from UE1, it may inform another relay UE candidate to UE1, or inform UE1 to select relay UE candidate by itself, or inform UE1 to abort the path establishment procedure. In some embodiments, each time the gNB may inform more than one U2U relay UE candidate to UE1, and it is up to UE1 to determine whether to perform the establishment procedure via one relay UE candidate at a time or via multiple relay UE candidates at the same time.

In some embodiments, UE1 may indicate one or more of the following info obtained from e.g., its serving gNB, in the discovery or link establishment request message that it sends out to another UE (e.g., UE2, or UE3):
IDs of one or multiple U2U relay UE candidates, i.e., those U2U relay UEs should be selected unless the path establishment is failed.
   A priority may be also signaled for each relay UE candidate
   The other UE may consider the priority when selecting the relay UE candidate, e.g., following a decreasing order of the priority
Whether U2U relay UEs not indicated in the discovery or link establishment request message can be selected by the other UE.

In some embodiments, when another remote UE (e.g., UE3) receives the discovery or link establishment request message, it may determine via which relay UE(s) the path shall/could be established based on the received info.

In some embodiments, whenever UE1 has declares a failure event in the procedure of relay path establishment towards another remote UE (e.g., UE3), UE1 may report to gNB1 indicating detection/declaration of the failure event via at least one of the following signaling alternatives
RRC signaling (i.e., Uu RRC signaling);
MAC CE;
L1 signaling (carried on the physical channels including PUSCH, PUCCH etc.).

In some embodiments, the signaling may comprise at least one of the following information:
Failure cause.
   e.g., failure of U2U relay path establishment.
reporting UE ID (e.g., ID of UE1).
relay UE candidates to which relay path establishment was attempted during the procedure (since the last failure report).
Whether it is allowed to try additional relay UE candidates (e.g., whether the common timer for all the relay UE candidates is still running).

### Group B Embodiments—Relay Path Monitoring

In some embodiments, as soon as UE1 has established a U2U relay link to another remote UE (e.g., UE3) via at least a relay UE (e.g., UE2), UE1 may monitor and measure the relay path in terms of metrics including at least one of the following:
Radio channel quality metrics on any hop including RSRP, RSRQ, RSSI, SINR, SIR, BLER etc.
Transmission failure rate and/or retransmission ratio.
   HARQ failure rate and/or retransmission ratio.
   RLC PDU failure rate and/or retransmission ratio.
QoS metrics including bit rate, packet delay, packet error rate etc.
Congestion metrics including channel busy ratio (CBR), channel usage ratio (CR), channel occupancy in case of unlicensed operation, LBT success/failure ratio in case of unlicensed operation etc.

In some embodiments, UE1 may formulate a report message accordingly comprising measurement results in terms of one or multiple above metrics, and send the report to gNB1 via at least one of the following signaling alternatives:
RRC signaling (i.e., Uu RRC signaling);
MAC CE;
L1 signaling (carried on the physical channels including PUSCH, PUCCH etc.).

In some embodiments, the measurement may be performed by UE1 per destination UE/neighbor UE, hop, service, radio bearer, LCH, or LCH group.

In some embodiments, the measurement report may be triggered according to at least one of the following fashions:
Periodical report;
Event trigger;
Upon reception of a request message from gNB1 for requesting measurement report.

In some embodiments, UE1 may measure the relay path in terms of one or multiple end to end metrics e.g., E2E QoS metrics including bit rate, packet delay, packet error rate etc.
In an example, UE1 may measure E2E packet delay at a certain protocol layer (e.g., PDCP)
In an example, UE1 may formulate E2E measurements by summarizing per hop measurement results. As an option, UE1 may determine E2E measurement results as the average/maximum/minimum/sum of per hop measurement results. As another option, UE1 may determine E2E measurement results as output of a mathematic function considering per hop measurement results as inputs.

### Group C Embodiments—Relay Path RLF Handling

In some embodiments, UE1 may declare an RLF for the relay path when RLF is declared/detected on any hop of the path.

In some embodiments, an RLF event may be declared by other UE for any other hop on the same relay path. In this case, the RLF event can be informed to UE1 by the other UE via PC5 RRC signaling, Control PDU of a protocol layer (e.g., an adaption layer which is responsible for the relay function), MAC CE or L1 signaling (carried on physical channel including PSSCH, PSCCH, PSFCH etc.).

In some embodiments, UE1 may signal gNB1 of an RLF event when UE1 detects the RLF event for the relay path by itself or UE1 receives the RLF event for the relay path from other UEs. In some embodiments, UE1 may report to gNB1 indicating detection/declaration of the RLF via RRC signaling (i.e., Uu RRC signaling), MAC CE or L1 signaling (carried on the physical channels including PUSCH, PUCCH etc.).

In some embodiments, the signaling may comprise at least one of the following information:
Failure cause.
   e.g., RLF on a hop of the U2U relay path.
the hop where the RLF is detected.
   hop index.
   IDs of the two UEs associated with the hop.
reporting UE ID (e.g., ID of UE1).
destination UE ID (e.g., ID of UE3).

Please note that UE1 may communicate with multiple UEs over SL simultaneously, in this case the destination UE ID is needed to identify for which end to end path the RLF event is relevant.

### Group D Embodiments-Network Embodiments

In one embodiment, whenever gNB1 receives a report message from UE1 on the relay path (as described in any one of the above embodiments), gNB1 may determine to perform one of the below actions for UE1:
Reconfigure the existing relay path including:
   For one or multiple radio bearers, reconfigure the mapping to RLC channels on each hop, e.g., an RB is remapped to a different RLC channel on one hop.
   For one or multiple radio bearers, reconfigure QoS split among hops, e.g., the percentage/the split ratio of a QoS requirement (e.g., packet delay budget) for one hop is adjusted (to be higher or lower than before).
Signal one or multiple additional relay UE candidates to UE1.
   Based on this, UE1 uses the additional relay UE candidates to replace the existing relay UE on the relay path.
Reconfigure the RB(s) that are transmitted on the relay path with RLF detected to a Uu path w/o RLF detected and continue the transmission on the Uu path.
Release the relay path.
Assigning more resources to the relay path.
Select different resource pool(s).
Select different carrier(s).

In some embodiments, gNB1 may inform other UE(s) that connect to UE2 (i.e., relay UE for UE1) to select a different path and/or different resource pool(s) and/or different carrier(s).

### Group E Embodiments—Other Embodiments

In one embodiment, for any other UE (except UE1) on the relay path, if the other UE is in network coverage, the other UE may receive a request message from UE1 (e.g., for establishing the relay path, or reselect a different relay UE or reconfigure certain configuration for the relay path). In some embodiments, the other UE may further forward the signaling message to its serving gNB (e.g., gNB2). In some embodiments, the gNB may further reply to the other UE indicating whether to accept or reject the request message. In some embodiments, the other UE thereby may respond to UE1 with the gNB's decision.

In some embodiments, for any one of the above embodiments, for any other UE (except UE1) on the relay path, if the other UE is in network coverage, the other UE may send a report message to its serving gNB (same as UE1 as described in any previous embodiment). In some embodiments, the gNB receiving the report may take at least one of the following actions e.g.:
Forward the report message to gNB1.
Instructing the other UE to take further at least one of the following actions,
   Forwarding the report message to UE1 via the SL connection.
   Indicating to UE1 that the relay path needs to be reconfigured.
   Indicating to UE1 that the relay UE on the relay path needs to be reselected.
   Indicating to UE1 that the relay path needs to be released.
   Indicating to UE1 that certain RBs need to be remapped to a Uu path.
Inform gNB1 that the relay path needs to be reconfigured/reselected/released and/or certain RBs need to be reconfigured/remapped to Uu path. In some embodiments, gNB1 may further inform UE1 to take the corresponding actions.

With some embodiments of the present disclosure, UE can select a most suitable U2U relay UE to establish a relay path towards a destination UE. Further, SL transmissions may be avoided in case of U2U relay creating interference to Uu transmissions.

FIG. 5 is a flow chart of an exemplary method 500 at a first UE for performing a U2U communication with a second UE via one or more U2U relay UEs according to an embodiment of the present disclosure. The method 500 may be performed at a UE (e.g., the UE 100-1) for network controlled U2U relay link maintenance. The method 500 may comprise steps S510 and S520. However, the present disclosure is not limited thereto. In some other embodiments, the method 500 may comprise more steps, less steps, different steps, or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where a message indicating control information for the U2U communication may be received from a network node.

At step S520 the first UE may communicate with the second UE and/or at least one of the one or more U2U relay UEs for the U2U communication based on at least the indicated control information.

In some embodiments, the message may comprise at least one of: system information that carries cell specific configuration applicable to all UEs in a cell; a paging message that carries control information for one or more UEs that are paged; an RRC message that carries UE specific control information and/or cell specific control information; a Control PDU of a protocol layer; a MAC CE; and L1 signaling. In some embodiments, the control information may indicate one or more U2U relay UE candidates via which the first UE shall set up a U2U relay path to the second UE.

In some embodiments, the control information may further indicate at least one of: one or more traffic types or services that shall be transmitted via a U2U relay UE; one or more IDs of the one or more U2U relay UE candidates; an indicator indicating whether a U2U relay UE that is not indicated by the control information can be selected by the first UE or not; an L2 configuration to be set up at the first UE based on a number of hops; a priority order of the one or more U2U relay UE candidates; a timer value indicating a maximum time period during which the first UE needs to provide a response message to the network node during a U2U relay path establishment procedure; a maximum number of the one or more U2U relay UE candidates that can be tried; and a maximum number of U2U relay UEs that are not indicated by the control information and that can be tried.

In some embodiments, data associated with a traffic type or a service that is not indicated by the control information may be transmitted by the first UE over a Uu path while data associated with a traffic type or a service that is indicated by the control information may be transmitted by the first UE over a U2U relay path. In some embodiments, the control information may indicate that data associated with a traffic type or a service is to be transmitted by the first UE over a U2U path, a U2N path, or a Uu path. In some embodiments, an ID of a U2U relay UE candidate may comprise at least one of: an SL ID to identify a corresponding U2U relay UE candidate; a Uu ID to identify a corresponding U2U relay UE candidate; and a temporary ID assigned to a corresponding U2U relay UE candidate. In some embodiments, after the step of receiving the message and before the step of communicating with the second UE and/or the at least one U2U relay UE, the method 500 may further comprise at least one of: determining one of the U2U relay UE candidates indicated by the control information as a target U2U relay UE; starting a timer for the target U2U relay UE with the timer value indicated by the control information, wherein the step of communicating with the second UE and/or the at least one U2U relay UE may comprise: performing a U2U relay path establishment procedure to set up a U2U relay path to the second UE via the target U2U relay UE.

In some embodiments, the method 500 may further comprise at least one of: stopping the timer when the first UE has successfully established the U2U relay path; declaring a failure event when the timer is expired; reselecting a different one of the U2U relay UE candidates when the timer is expired; reselecting a U2N relay UE when the timer is expired; and reselecting a Uu path when the timer is expired. In some embodiments, the L2 configuration indicated by the control information may be applied by the first UE during the U2U relay path establishment procedure. In some embodiments, when the priority order of the one or more U2U relay UE candidates is indicated by the control information, a U2U relay path establishment procedure may be attempted by the first UE towards each of the one or more U2U relay UE candidates in the indicated priority order. In some embodiments, the priority order may be determined based on at least one of: one or more measurements between any two of the first UE, the second UE, and the one or more U2U relay UE candidates that have a direct link therebetween; and a load status at each of the one or more U2U relay UE candidates.

In some embodiments, when a common timer value for all U2U relay UE candidates is indicated by the control information, the method 500 may further comprise at least one of: starting a timer when a U2U relay path establishment procedure for establishing a U2U relay path to the second UE is initiated for the first time; stopping the U2U relay path establishment procedure when the U2U relay path to the second UE is successfully established; stopping the timer when the U2U relay path to the second UE is successfully established; stopping the U2U relay path establishment procedure when the timer is expired; stopping the U2U relay path establishment procedure when U2U relay path establishment procedures for all of the U2U relay UE candidates fail; declaring a failure event when the timer is expired; and declaring a failure event when U2U relay path establishment procedures for all of the U2U relay UE candidates fail. In some embodiments, when one or more other timer values, which are associated with one or more U2U relay UE candidates, respectively, are indicated by the control information, the method 500 may further comprise, for each of the other timer values, at least one of: starting another timer when a U2U relay path establishment procedure is started to be performed towards an associated U2U relay UE candidate; stopping the U2U relay path establishment procedure when the U2U relay path to the second UE is successfully established via the associated U2U relay UE candidate; stopping the other timer when the U2U relay path to the second UE is successfully established via the associated U2U relay UE candidate; stopping the U2U relay path establishment procedure, which is performed towards the associated U2U relay UE candidate, when the other timer is expired; stopping the U2U relay path establishment procedure, which is performed towards the associated U2U relay UE candidate, when the U2U relay path establishment procedure fails for the associated U2U relay UE candidate; starting a next U2U relay path establishment procedure, which is performed towards a next U2U relay UE candidate, when the other timer is expired; and starting a next U2U relay path establishment procedure, which is performed towards a next U2U relay UE candidate, when the U2U relay path establishment procedure fails for the associated U2U relay UE candidate.

In some embodiments, when separate timer values, which are associated with the U2U relay UE candidates, respectively, are indicated by the control information, the method 500 may further comprise, for each of the separate timer values, at least one of: starting a timer when a U2U relay path establishment procedure for establishing a U2U relay path to the second UE via an associated U2U relay UE candidate is initiated; stopping the U2U relay path establishment procedure when the U2U relay path to the second UE is successfully established via the associated U2U relay UE candidate; stopping the timer when the U2U relay path to the second UE is successfully established via the associated U2U relay UE candidate; stopping the U2U relay path establishment procedure when the timer is expired; stopping the U2U relay path establishment procedure when the U2U relay path establishment procedure fails for the associated U2U relay UE candidate; declaring a failure event when the timer is expired; declaring a failure event when the U2U relay path establishment procedure fails; starting a next U2U relay path establishment procedure, which is performed towards a next U2U relay UE candidate, when the timer is expired; and starting a next U2U relay path establishment procedure, which is performed towards a next U2U relay UE candidate, when the U2U relay path establishment procedure fails.

In some embodiments, the step of declaring a failure event may comprise: transmitting, to the network node, the failure event together with an identifier of the associated U2U relay UE candidate. In some embodiments, when the control information indicates an L2 configuration to be set up at the first UE, the L2 configuration may indicate at least one of: a number of hops involved; one or more measurements between any two of the first UE, the second UE, and the one or more U2U relay UE candidates that have a direct link therebetween; and an E2E PDB required to support a service; and an E2E PER required to support a service. In some embodiments, when the control information indicates only one U2U relay UE candidate, the method 500 may further comprise: in response to the first UE declaring a failure event associated with the U2U relay UE candidate indicated by the control information, receiving, from the network node a message indicating at least one of: another control information indicating another U2U relay UE candidate; that the first UE is to select another U2U relay UE candidate by itself; and that the first UE is to abort the U2U relay path establishment procedure.

In some embodiments, when the control information indicates multiple U2U relay UE candidates, whether a U2U relay path establishment procedure is performed towards one U2U relay UE candidate at a time or towards multiple U2U relay UE candidates at the same time may be up to the first UE to determine. In some embodiments, the step of communicating with the second UE and/or the at least one U2U relay UE may comprise: transmitting, to second UE and/or the at least one U2U relay UE, a discovery message or a link establishment request message indicating at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not. In some embodiments, a failure event may be reported by the first UE to the network node via at least one of: RRC signaling; MAC CE; and L1 signaling. In some embodiments, the failure event may indicate at least one of: a failure cause; an ID of the first UE; one or more U2U relay UE candidates to which one or more U2U relay path establishment procedures were attempted since the last failure event was reported; and whether the first UE is allowed to try additional U2U relay UE candidates.

In some embodiments, when a U2U relay path to the second UE is successfully established via at least one U2U relay UE, the method 500 may further comprise: monitoring and/or measuring the U2U relay path. In some embodiments, the U2U relay path may be monitored and/or measured in terms of at least one of: one or more radio channel quality metrics on any hop between any two of the first UE, the second UE, and the at least one U2U relay UE that have a direct link therebetween; a transmission failure rate; a retransmission ratio; one or more QoS metrics; and one or more congestion metrics. In some embodiments, at least one of following may be true: a radio channel quality metric may comprise at least one of RSRP, RSRQ, RSSI, SINR, SIR, and BLER; a transmission failure rate may comprise at least one of a HARQ failure rate and an RLC PDU failure rate; a retransmission ratio may comprise at least one of a HARQ retransmission ratio and an RLC PDU retransmission ratio; a QoS metric may comprise at least one of a bit rate, a packet delay, and a packet error rate; and a congestion metric may comprise at least one of a CBR, a CR, a channel occupancy in case of unlicensed operation, an LBT success/failure ratio in case of unlicensed operation.

In some embodiments, the method 500 may further comprise: transmitting, to the network node, a report message reporting one or more measurement results associated with the U2U relay path. In some embodiments, the report message may be transmitted via at least one of: RRC signaling; MAC CE; and L1 signaling. In some embodiments, a measurement may be performed by the first UE according to one of: per destination UE, per neighbor UE, per hop, per service, per radio bearer, per LCH, and per LCH group. In some embodiments, a report message may be triggered periodically and/or by at least one of: a trigger event; and upon reception of a request message from the network node for requesting a measurement report. In some embodiments, the U2U relay path may be measured by the first UE in terms of one or more E2E metrics comprising at least one of: an E2E bit rate; an E2E packet delay; and an E2E packet error rate. In some embodiments, an E2E packet delay may be measured at the PDCP layer. In some embodiments, an E2E metric may be determined based on at least per-hop measurement results along the U2U relay path. In some embodiments, the E2E metric may be determined as: a sum of the per-hop measurement results along the U2U relay path; an average of the per-hop measurement results along the U2U relay path; a maximum of the per-hop measurement results along the U2U relay path; a minimum of the per-hop measurement results along the U2U relay path; and an output of a mathematic function, which has the per-hop measurement results along the U2U relay path as inputs.

In some embodiments, the method 500 may further comprise: declaring an RLF event for the U2U relay path in response to determining an RLF event on any hop of the U2U relay path. In some embodiments, the step of determining an RLF event on any hop of the U2U relay path may comprise at least one of: detecting an RLF event on a hop between the first UE and its neighbor U2U relay UE along the U2U relay path; and receiving, from another UE, an indication of an RLF event on a hop of the U2U relay path that is not a hop between the first UE and its neighbor U2U relay UE along the U2U relay path. In some embodiments, the step of declaring the RLF event for the U2U relay path may comprise: transmitting, to the network node, a message indicating the RLF event. In some embodiments, the RLF event may indicate at least one of: a failure cause; the hop where the RLF event is detected; an ID of the first UE; and an ID of the second UE. In some embodiments, after the step of transmitting a report message, the method 500 may further comprise: receiving, from the network node, another message indicating at least one of: a configuration to reconfigure the existing U2U relay path; one or more additional U2U relay UE candidates for the first UE to replace one or more existing U2U relay UEs on the U2U relay path; a configuration to reconfigure one or more RBs that are transmitted on the U2U relay path with an RLF event detected to a Uu path without an RLF event detected and to continue the corresponding transmission on the Uu path; an indication to release the U2U relay path; one or more additional resources assigned to the U2U relay path; one or more resource pools different from the one or more resource pools that are currently selected; and one or more carriers different from the one or more carriers that are currently selected.

In some embodiments, the step of communicating with the second UE and/or at least one of the one or more U2U relay UEs may comprise: transmitting, to the second UE and/or at least one of the one or more U2U relay UEs, a request message; and receiving, from the second UE and/or the at least one of the one or more U2U relay UEs, a response message indicating whether the request message is accepted or rejected by a network node associated with the second UE and/or at least one of the one or more U2U relay UEs. In some embodiments, the method 500 may further comprise at least one of: receiving, from the second UE and/or at least one of the one or more U2U relay UEs, a report message via a sidelink connection; receiving, from the second UE and/or at least one of the one or more U2U relay UEs, a message indicating that the U2U relay path needs to be reconfigured; receiving, from the second UE and/or at least one of the one or more U2U relay UEs, a message indicating that one or more U2U relay UEs on the U2U relay path needs to be reselected; receiving, from the second UE and/or at least one of the one or more U2U relay UEs, a message indicating that the U2U relay path needs to be released; and receiving, from the second UE and/or at least one of the one or more U2U relay UEs, a message indicating that one or more specific RBs need to be remapped to a Uu path.

In some embodiments, the method 500 may further comprise at least one of: receiving, from the network node, a message indicating that the U2U relay path needs to be reconfigured; receiving, from the network node, a message indicating that one or more U2U relay UEs on the U2U relay path needs to be reselected; receiving, from the network node, a message indicating that the U2U relay path needs to be released; and receiving, from the network node, a message indicating that one or more specific RBs need to be remapped to a Uu path.

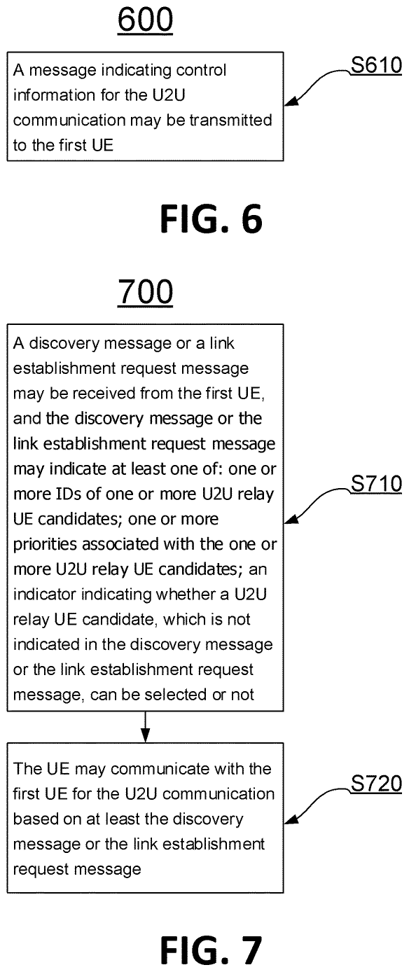

FIG. 6 is a flow chart of an exemplary method 600 at a network node for facilitating a first UE in performing a U2U communication with a second UE via one or more U2U relay UEs according to an embodiment of the present disclosure. The method 600 may be performed at a network node (e.g., the gNB 105-1) for network controlled U2U relay link maintenance. The method 600 may comprise a step S610. However, the present disclosure is not limited thereto. In some other embodiments, the method 600 may comprise more steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where a message indicating control information for the U2U communication may be transmitted to the first UE.

In some embodiments, the message may comprise at least one of: system information that carries cell specific configuration applicable to all UEs in a cell; a paging message that carries control information for one or more UEs that are paged; an RRC message that carries UE specific control information and/or cell specific control information; a Control PDU of a protocol layer; a MAC CE; and L1 signaling. In some embodiments, the control information may indicate one or more U2U relay UE candidates via which the first UE shall set up a U2U relay path to the second UE. In some embodiments, the control information may further indicate at least one of: one or more traffic types or services that shall be transmitted via a U2U relay UE; one or more IDs of the one or more U2U relay UE candidates; an indicator indicating whether a U2U relay UE that is not indicated by the control information can be selected by the first UE or not; an L2 configuration to be set up at the first UE based on a number of hops; a priority order of the one or more U2U relay UE candidates; a timer value indicating a maximum time period during which the first UE needs to provide a response message to the network node during a U2U relay path establishment procedure; a maximum number of the one or more U2U relay UE candidates that can be tried; and a maximum number of U2U relay UEs that are not indicated by the control information and that can be tried.

In some embodiments, data associated with a traffic type or a service that is not indicated by the control information may be transmitted by the first UE over a Uu path while data associated with a traffic type or a service that is indicated by the control information may be transmitted by the first UE over a U2U relay path. In some embodiments, the control information may indicate that data associated with a traffic type or a service is to be transmitted by the first UE over a U2U path, a U2N path, or a Uu path. In some embodiments, an ID of a U2U relay UE candidate may comprise at least one of: an SL ID to identify a corresponding U2U relay UE candidate; a Uu ID to identify a corresponding U2U relay UE candidate; and a temporary ID assigned to a corresponding U2U relay UE candidate. In some embodiments, the L2 configuration indicated by the control information may be applied by the first UE during a U2U relay path establishment procedure.

In some embodiments, when the priority order of the one or more U2U relay UE candidates is indicated by the control information, a U2U relay path establishment procedure may be attempted by the first UE towards each of the one or more U2U relay UE candidates in the indicated priority order. In some embodiments, the priority order may be determined based on at least one of: one or more measurements between any two of the first UE, the second UE, and the one or more U2U relay UE candidates that have a direct link therebetween; and a load status at each of the one or more U2U relay UE candidates. In some embodiments, when a common timer value for all U2U relay UE candidates is indicated by the control information, the first UE may be expected to stop trying to establish a U2U relay path to the second UE via any U2U relay UE candidate when a timer started with the common timer value is expired. In some embodiments, when one or more other timer values, which are associated with one or more U2U relay UE candidates, respectively, are indicated by the control information, for each of the one or more other timer values, the first UE may be expected to stop trying to establish a U2U relay path to the second UE via an associated U2U relay UE candidate when another timer started with the corresponding other timer value is expired. In some embodiments, when separate timer values, which are associated with the U2U relay UE candidates, respectively, are indicated by the control information, for each of the separate timer values, the first UE may be expected to stop trying to establish a U2U relay path to the second UE via an associated U2U relay UE candidate when a timer started with the corresponding separate timer value is expired.

In some embodiments, the method 600 may further comprise: receiving, from the first UE, a failure event together with an identifier of an associated U2U relay UE candidate. In some embodiments, when the control information indicates an L2 configuration to be set up at the first UE, the L2 configuration may indicate at least one of: a number of hops involved; one or more measurements between any two of the first UE, the second UE, and the one or more U2U relay UE candidates that have a direct link therebetween; and an E2E PDB required to support a service; and an E2E PER required to support a service. In some embodiments, when the control information indicates only one U2U relay UE candidate, the method 600 may further comprise: transmitting, to the first UE, a message indicating at least one of: another control information indicating another U2U relay UE candidate; that the first UE is to select another U2U relay UE candidate by itself; and that the first UE is to abort the U2U relay path establishment procedure. In some embodiments, when the control information indicates multiple U2U relay UE candidates, whether a U2U relay path establishment procedure is performed towards one U2U relay UE candidate at a time or towards multiple U2U relay UE candidates at the same time may be up to the first UE to determine. In some embodiments, a failure event may be reported by the first UE to the network node via at least one of: RRC signaling; MAC CE; and L1 signaling. In some embodiments, the failure event may indicate at least one of: a failure cause; an ID of the first UE; one or more U2U relay UE candidates to which one or more U2U relay path establishment procedures were attempted since the last failure event was reported; and whether the first UE is allowed to try additional U2U relay UE candidates.

In some embodiments, the method 600 may further comprise: receiving, from the first UE, a report message reporting one or more measurement results associated with a U2U relay path. In some embodiments, the report message may be transmitted via at least one of: RRC signaling; MAC CE; and L1 signaling. In some embodiments, a measurement may be performed by the first UE according to one of: per destination UE, per neighbor UE, per hop, per service, per radio bearer, per LCH, and per LCH group. In some embodiments, a report message may be triggered periodically and/or by at least one of: a trigger event; and upon reception of a request message from the network node for requesting a measurement report. In some embodiments, the U2U relay path may be measured by the first UE in terms of one or more E2E metrics comprising at least one of: an E2E bit rate; an E2E packet delay; and an E2E packet error rate. In some embodiments, an E2E packet delay may be measured at the PDCP layer. In some embodiments, an E2E metric may be determined based on at least per-hop measurement results along the U2U relay path. In some embodiments, the E2E metric may be determined as: a sum of the per-hop measurement results along the U2U relay path; an average of the per-hop measurement results along the U2U relay path; a maximum of the per-hop measurement results along the U2U relay path; a minimum of the per-hop measurement results along the U2U relay path; and an output of a mathematic function, which has the per-hop measurement results along the U2U relay path as inputs.

In some embodiments, the method 600 may further comprise: receiving, from the first UE, a message indicating an RLF event on the U2U relay path. In some embodiments, the RLF event may indicate at least one of: a failure cause; the hop where the RLF event is detected; an ID of the first UE; and an ID of the second UE. In some embodiments, after the step of receiving a report message, the method 600 may further comprise at least one of: reconfiguring the existing U2U relay path; signaling one or more additional U2U relay UE candidates for the first UE to replace one or more existing U2U relay UEs on the U2U relay path; reconfiguring one or more RBs that are transmitted on the U2U relay path with an RLF event detected to a Uu path without an RLF event detected and continuing the corresponding transmission on the Uu path; releasing the U2U relay path; assigning one or more additional resources to the U2U relay path; selecting one or more resource pools different from the one or more resource pools that are currently selected; and selecting one or more carriers different from the one or more carriers that are currently selected. In some embodiments, the step of reconfiguring the existing U2U relay path may comprise at least one of: reconfiguring one or more mappings from one or more RBs to RLC channels on each hop; and reconfiguring QoS split among hops for one or more RBs.

In some embodiments, the method 600 may further comprise at least one of: receiving, from another network node, a message indicating that the U2U relay path needs to be reconfigured, and transmitting, to the first UE, a message indicating that the U2U relay path needs to be reconfigured; receiving, from another network node, a message indicating that one or more U2U relay UEs on the U2U relay path needs to be reselected, and transmitting, to the first UE, a message indicating that one or more U2U relay UEs on the U2U relay path needs to be reselected; receiving, from another network node, a message indicating that the U2U relay path needs to be released, and transmitting, to the first UE, a message indicating that the U2U relay path needs to be released; and receiving, from another network node, a message indicating that one or more specific RBs need to be remapped to a Uu path, and transmitting, to the first UE, a message indicating that one or more specific RBs need to be remapped to a Uu path.

FIG. 7 is a flow chart of an exemplary method 700 at a UE for facilitating a first UE in performing a U2U communication with a second UE via one or more U2U relay UEs according to an embodiment of the present disclosure. The method 700 may be performed at a UE (e.g., the UE 100-2, the UE 100-3, or the UE 100-4) for network controlled U2U relay link maintenance. The method 700 may comprise steps S710 and S720. However, the present disclosure is not limited thereto. In some other embodiments, the method 700 may comprise more steps, less steps, different steps, or any combination thereof. Further the steps of the method 700 may be performed in a different order than that described herein. Further, in some embodiments, a step in the method 700 may be split into multiple sub-steps and performed by different entities, and/or multiple steps in the method 700 may be combined into a single step.

The method 700 may begin at step S710 where a discovery message or a link establishment request message may be received from the first UE. In some embodiments, the discovery message or the link establishment request message may indicate at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not.

At step S720, the UE may communicate with the first UE for the U2U communication based on at least the discovery message or the link establishment request message.

In some embodiments, the UE may be the second UE or one of the U2U relay UEs. In some embodiments, when a U2U relay path is successfully established between the first UE and the second UE via at least one U2U relay UE, the method 700 may further comprise: monitoring and/or measuring the U2U relay path. In some embodiments, the U2U relay path may be monitored and/or measured in terms of at least one of: one or more radio channel quality metrics on any hop between any two of the first UE, the second UE, and the at least one U2U relay UE that have a direct link therebetween; a transmission failure rate; a retransmission ratio; one or more QoS metrics; and one or more congestion metrics. In some embodiments, at least one of following may be true: a radio channel quality metric may comprise at least one of RSRP, RSRQ, RSSI, SINR, SIR, and BLER; a transmission failure rate may comprise at least one of a HARQ failure rate and a RLC PDU failure rate; a retransmission ratio may comprise at least one of a HARQ retransmission ratio and an RLC PDU retransmission ratio; a QoS metric may comprise at least one of a bit rate, a packet delay, and a packet error rate; and a congestion metric may comprise at least one of a CBR, a CR, a channel occupancy in case of unlicensed operation, an LBT success/failure ratio in case of unlicensed operation.

In some embodiments, the method 700 may further comprise: transmitting, to a network node, a report message reporting one or more measurement results associated with the U2U relay path. In some embodiments, the report message may be transmitted via at least one of: RRC signaling; MAC CE; and L1 signaling. In some embodiments, a measurement may be performed by the UE according to one of: per destination UE, per neighbor UE, per hop, per service, per radio bearer, per LCH, and per LCH group. In some embodiments, a report message may be triggered periodically and/or by at least one of: a trigger event; and upon reception of a request message from the network node for requesting a measurement report. In some embodiments, the step of communicating with the first UE may comprise: forwarding, from the first UE to a network node associated with the UE, a request message; and forwarding, from the network node to the first UE, a response message indicating whether the request message is accepted or rejected by the network node. In some embodiments, the step of communicating with the first UE may comprise at least one of: transmitting, to the first UE, a report message via a sidelink connection; transmitting, to the first UE, a message indicating that the U2U relay path needs to be reconfigured; transmitting, to the first UE, a message indicating that one or more U2U relay UEs on the U2U relay path needs to be reselected; transmitting, to the first UE, a message indicating that the U2U relay path needs to be released; and transmitting, to the first UE, a message indicating that one or more specific RBs need to be remapped to a Uu path.

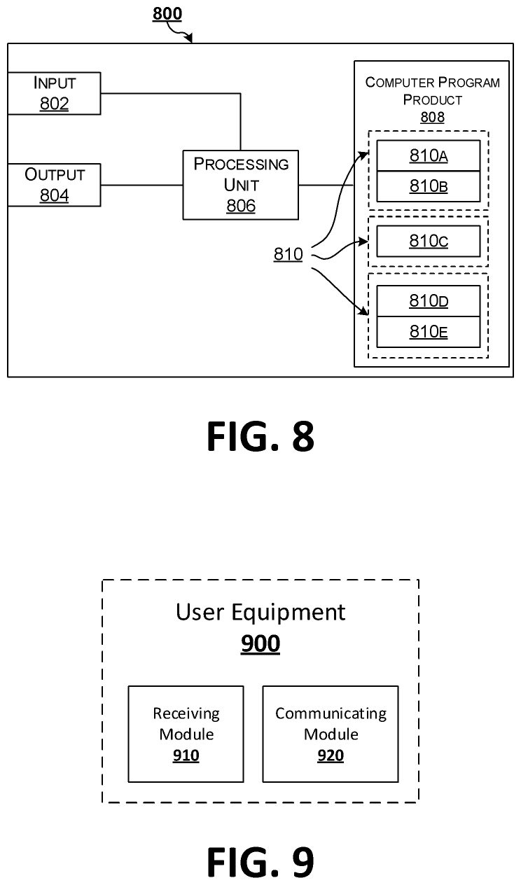

FIG. 8 schematically shows an embodiment of an arrangement which may be used in UEs and/or a network node according to an embodiment of the present disclosure. Comprised in the arrangement 800 are a processing unit 806, e.g., with a Digital Signal Processor (DSP) or a Central Processing Unit (CPU). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity or as separate entities.

Furthermore, the arrangement 800 may comprise at least one computer program product 808 in the form of a non-volatile or volatile memory, e.g., an Electrically Erasable Programmable Read-Only Memory (EEPROM), a flash memory and/or a hard drive. The computer program product 808 comprises a computer program 810, which comprises code/computer readable instructions, which when executed by the processing unit 806 in the arrangement 800 causes the arrangement 800 and/or the UEs and/or the network node in which it is comprised to perform the actions, e.g., of the procedure described earlier in conjunction with FIG. 3 through FIG. 7 or any other variant.

The computer program 810 may be configured as a computer program code structured in computer program modules 810A and 810B. Hence, in an exemplifying embodiment when the arrangement 800 is used in a first UE for performing a U2U communication with a second UE via one or more U2U relay UEs, the code in the computer program of the arrangement 800 includes: a module 810A configured to receive, from a network node, a message indicating control information for the U2U communication; and a module 810B configured to communicate with the second UE and/or at least one of the one or more U2U relay UEs for the U2U communication based on at least the indicated control information.

Additionally or alternatively, the computer program 810 may be further configured as a computer program code structured in a computer program module 810C. Hence, in an exemplifying embodiment when the arrangement 800 is used in a network node for facilitating a first UE in performing a U2U communication with a second UE via one or more U2U relay UEs, the code in the computer program of the arrangement 800 includes: a module 810C configured to transmit, to the first UE, a message indicating control information for the U2U communication.

Additionally or alternatively, the computer program 810 may be further configured as a computer program code structured in computer program modules 810D and 810E. Hence, in an exemplifying embodiment when the arrangement 800 is used in a UE for facilitating a first UE in performing a U2U communication with a second UE via one or more U2U relay UEs, the code in the computer program of the arrangement 800 includes: a module 810D configured to receive, from the first UE, a discovery message or a link establishment request message; and a module 810E configured to communicate with the first UE for the U2U communication based on at least the discovery message or the link establishment request message. In some embodiments, the discovery message or the link establishment request message may indicate at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not. In some embodiments, the UE may be the second UE or one of the one or more U2U relay UEs.

The computer program modules could essentially perform the actions of the flow illustrated in FIG. 3 through FIG. 7, to emulate the first UE, the second UE, any of the U2U relay UE, and/or the network node. In other words, when the different computer program modules are executed in the processing unit 806, they may correspond to different modules in the UEs and/or the network node.

Although the code means in the embodiments disclosed above in conjunction with FIG. 8 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UEs and/or the network node.

Correspondingly to the method 500 as described above, an exemplary UE is provided. FIG. 9 is a block diagram of an exemplary UE 900 according to an embodiment of the present disclosure. The UE 900 may be, e.g., the UE 100-1 in some embodiments.

The UE 900 may be configured to perform the method 500 as described above in connection with FIG. 5. As shown in FIG. 9, the UE 900 may comprise a receiving module 910 configured to receive, from a network node, a message indicating control information for the U2U communication; and a communicating module 920 configured to communicate with the second UE and/or at least one of the one or more U2U relay UEs for the U2U communication based on at least the indicated control information.

The above modules 910 and 920 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the UE 900 may comprise one or more further modules, each of which may perform any of the steps of the method 500 described with reference to FIG. 5.

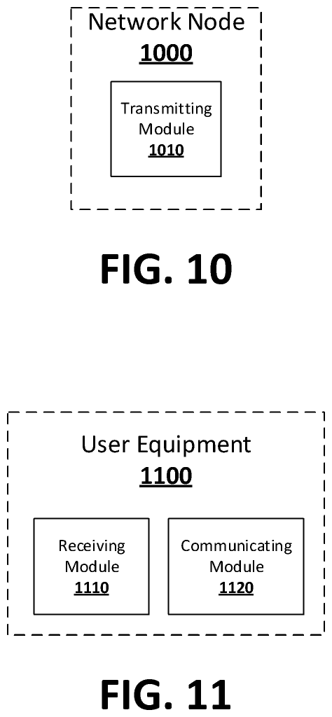

Correspondingly to the method 600 as described above, an exemplary network node is provided. FIG. 10 is a block diagram of an exemplary network node 1000 according to an embodiment of the present disclosure. The network node 1000 may be, e.g., the gNB 105-1 in some embodiments.

The network node 1000 may be configured to perform the method 600 as described above in connection with FIG. 6. As shown in FIG. 10, the network node 1000 may comprise a transmitting module 1010 configured to transmit, to the first UE, a message indicating control information for the U2U communication.

The above module 1010 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 6. Further, the network node 1000 may comprise one or more further modules, each of which may perform any of the steps of the method 600 described with reference to FIG. 6.

Correspondingly to the method 700 as described above, an exemplary UE is provided. FIG. 11 is a block diagram of an exemplary UE 1100 according to an embodiment of the present disclosure. The UE 1100 may be, e.g., the UE 100-2, the UE 100-3, or the UE 100-4 in some embodiments.

The UE 1100 may be configured to perform the method 700 as described above in connection with FIG. 7. As shown in FIG. 11, the UE 1100 may comprise a receiving module 1110 configured to receive, from the first UE, a discovery message or a link establishment request message; and a communicating module 1120 configured to communicate with the first UE for the U2U communication based on at least the discovery message or the link establishment request message. In some embodiments, the discovery message or the link establishment request message may indicate at least one of: one or more IDs of one or more U2U relay UE candidates; one or more priorities associated with the one or more U2U relay UE candidates; an indicator indicating whether a U2U relay UE candidate, which is not indicated in the discovery message or the link establishment request message, can be selected or not. In some embodiments, the UE may be the second UE or one of the one or more U2U relay UEs.

The above modules 1110 and 1120 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the UE 1100 may comprise one or more further modules, each of which may perform any of the steps of the method 700 described with reference to FIG. 7.

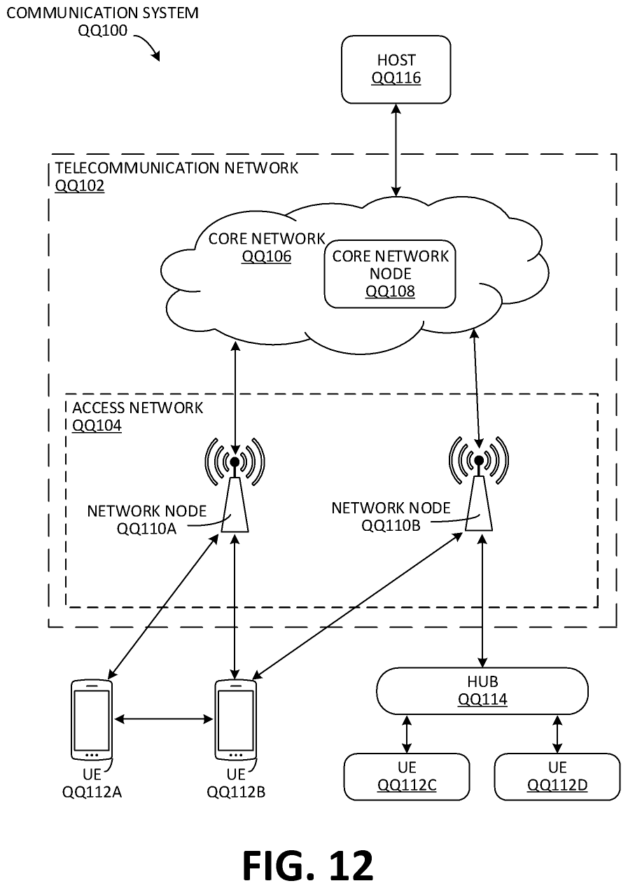

FIG. 12 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

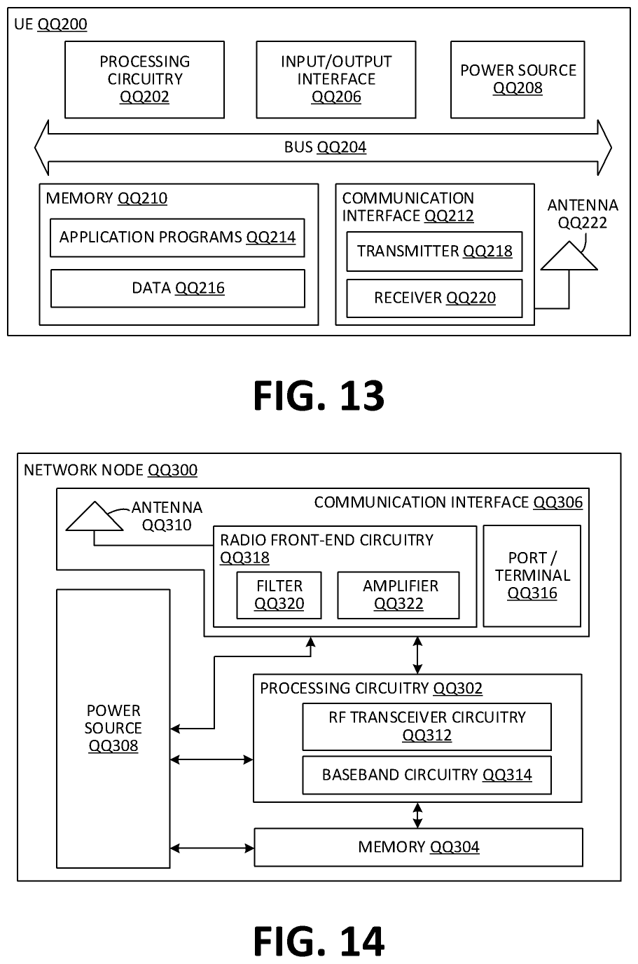

FIG. 13 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 14 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

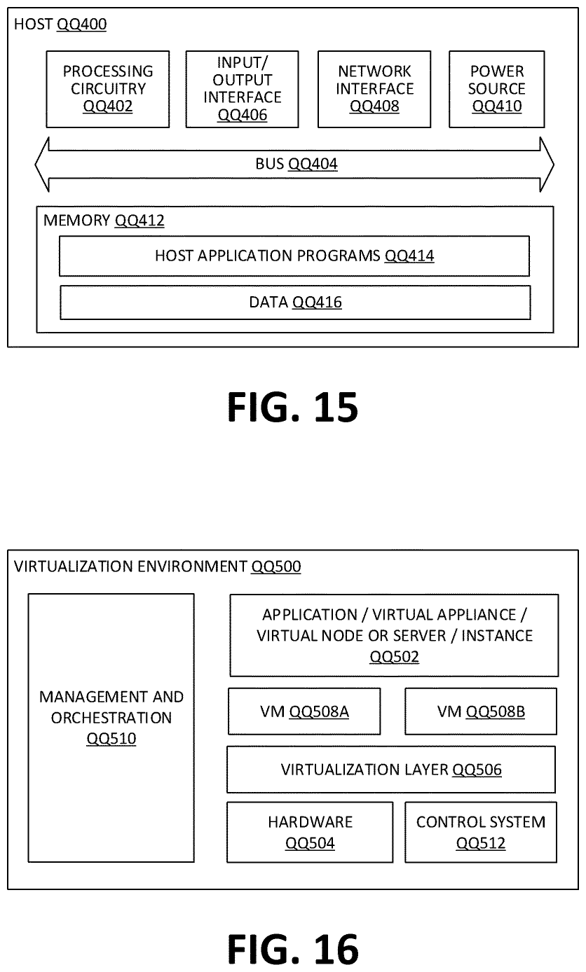

FIG. 15 is a block diagram of a host QQ400, which may be an embodiment of the host QQ116 of FIG. 12, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 13 and FIG. 14, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

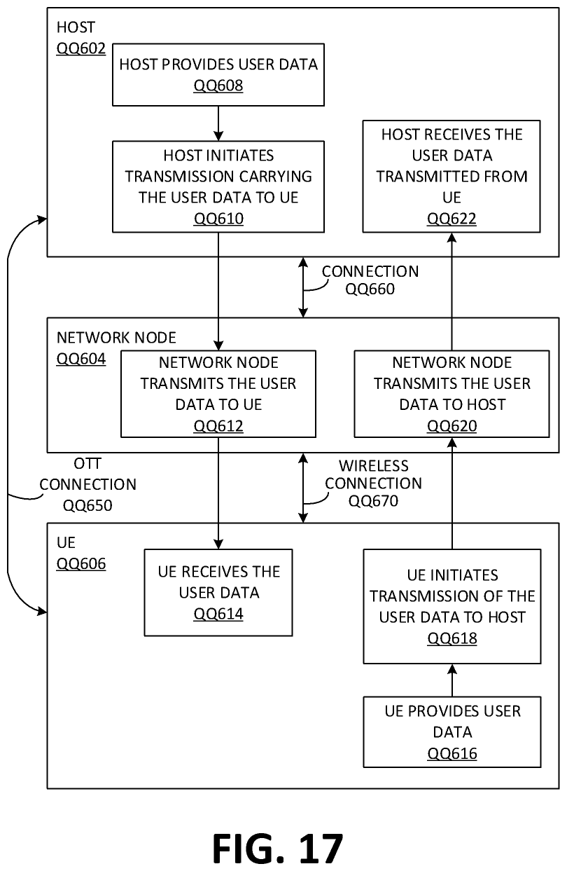

FIG. 17 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 12 and/or UE QQ200 of FIG. 13), network node (such as network node QQ110a of FIG. 12 and/or network node QQ300 of FIG. 14), and host (such as host QQ116 of FIG. 12 and/or host QQ400 of FIG. 15) discussed in the preceding paragraphs will now be described with reference to FIG. 17.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 12) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| 3GPP | 3^{rd} Generation Partnership Project |
| 4G | 4^{th} Generation |
| 5G | 5^{th} Generation |
| 6G | 6^{th} Generation |
| 5GC | 5G Core |
| 5GS | 5G System |
| AMF | Access and Mobility management Function |
| BSR | Buffer Status Reporting |
| BWP | Bandwidth Part |
| CB | Contention-Based |
| CN | Core Network |
| CORESET | Control Resource Set |
| CSS | Common Search Space |
| eNB | Evolved Node B (A radio base station in LTE) |
| E-UTRAN | Evolved Universal Terrestrial Radio Access Network |
| gNB | 5G Node B (A radio base station in NR) |
| IMEI | International Mobile Equipment Identity |
| LTE | Long Term Evolution |
| MBB | Mobile Broadband |
| MT | Mobile Terminated |
| MTC | Machine-Type Communication |
| NG | The interface/reference point between the RAN and the CN |
| | in 5G/NR |
| NG-C | The control plane part of NG (between a gNB and an AMF) |
| NG-RAN | Next Generation Radio Access Network |
| NG-U | The user plane part of NG (between a gNB and a UPF) |
| NR | New Radio |
| NSSAI | Network Slice Selection Assistance Information |
| OFDM | Orthogonal Frequency Division Multiplex |
| PDB | Packet Delay Budget |
| PDCCH | Physical Downlink Control Channel |
| PER | Packet Error Rate |
| PLMN | Public Land Mobile Network |
| PO | PRACH Occasion |
| PRACH | Physical Random Access Channel |
| PQI | PC5 QoS Identifier |
| PUSCH | Physical Uplink Shared Channel |
| RAN | Radio Access Network |
| RAR | Random Access Response |
| RB | Resource Block |
| RF | Radio Frequency |
| RFSP Index | RAT/Frequency Selection Priority Index |
| RLC | Radio Link Control |
| RRC | Radio Resource Control |
| S-NSSAI | Selected NSSAI |
| SN | Sequence Number |
| SPID | Subscriber Profile ID for RAT/Frequency Priority |
| SSB | Synchronization Signal Block |
| TA | Tracking Area |
| TS | Technical Specification |
| UDM | Unified Data Management |
| UE | User Equipment |
| UPF | User Plane Function |
| URLLC | Ultra-Reliable Low-Latency Communication |
| USIM | Universal Subscriber Identity Module |
| Xn | The interface/reference point between two gNBs |

1. A method at a first User Equipment (UE) for performing a UE-to-UE (U2U) communication with a second UE via one or more U2U relay UEs, the method comprising:
receiving, from a network node, a message indicating control information for the U2U communication; and
communicating with the second UE and/or at least one of the one or more U2U relay UEs for the U2U communication based on at least the indicated control information.

2. The method of claim 1, wherein the message comprises at least one of:
system information that carries cell specific configuration applicable to all UEs in a cell;
a paging message that carries control information for one or more UEs that are paged;
a Radio Resource Control (RRC) message that carries UE specific control information and/or cell specific control information;
a Control Protocol Data Unit (PDU) of a protocol layer;
a Medium Access Control (MAC) Control Element (CE); and
L1 signaling.

3. The method of claim 1, wherein the control information indicates one or more U2U relay UE candidates via which the first UE shall set up a U2U relay path to the second UE.

4. The method of claim 3, wherein the control information further indicates at least one of:
one or more traffic types or services that shall be transmitted via a U2U relay UE;
one or more identifiers (IDs) of the one or more U2U relay UE candidates;
an indicator indicating whether a U2U relay UE that is not indicated by the control information can be selected by the first UE or not;
an L2 configuration to be set up at the first UE based on a number of hops;
a priority order of the one or more U2U relay UE candidates;
a timer value indicating a maximum time period during which the first UE needs to provide a response message to the network node during a U2U relay path establishment procedure;
a maximum number of the one or more U2U relay UE candidates that can be tried; and
a maximum number of U2U relay UEs that are not indicated by the control information and that can be tried.

5. (canceled)

6. The method of claim 4, wherein the control information indicates that data associated with a traffic type or a service is to be transmitted by the first UE over a U2U path, a UE-to-Network (U2N) path, or a Uu path.

7. The method of claim 4, wherein an ID of a U2U relay UE candidate comprises at least one of:
a sidelink (SL) ID to identify a corresponding U2U relay UE candidate;
a Uu ID to identify a corresponding U2U relay UE candidate; and
a temporary ID assigned to a corresponding U2U relay UE candidate.

8-9. (canceled)

10. The method of claim 1, wherein the L2 configuration indicated by the control information is applied by the first UE during the U2U relay path establishment procedure.

11-16. (canceled)

17. The method of claim 1, wherein when the control information indicates an L2 configuration to be set up at the first UE, the L2 configuration indicates at least one of:
a number of hops involved;
one or more measurements between any two of the first UE, the second UE, and the one or more U2U relay UE candidates that have a direct link therebetween; and
an End-to-End (E2E) packet delay budge (PDB) required to support a service; and
an E2E packet error rate (PER) required to support a service.

18. The method of claim 1, wherein when the control information indicates only one U2U relay UE candidate, the method further comprises:
in response to the first UE declaring a failure event associated with the U2U relay UE candidate indicated by the control information,
receiving, from the network node a message indicating at least one of:
another control information indicating another U2U relay UE candidate;
that the first UE is to select another U2U relay UE candidate by itself; and
that the first UE is to abort the U2U relay path establishment procedure.

19. (canceled)

20. The method of claim 1, wherein the step of communicating with the second UE and/or the at least one U2U relay UE comprises:
transmitting, to second UE and/or the at least one U2U relay UE, a discovery message or a link establishment request message indicating at least one of:
one or more IDs of one or more U2U relay UE candidates;
one or more priorities associated with the one or more U2U relay UE candidates;
an indicator indicating whether a U2U relay UE candidate, which is not indicated in the discovery message or the link establishment request message, can be selected or not.

21. The method of claim 1, wherein a failure event is reported by the first UE to the network node via at least one of:
RRC signaling;
MAC CE; and
L1 signaling.

22. The method of claim 21, wherein the failure event indicates at least one of:
a failure cause;
an ID of the first UE;
one or more U2U relay UE candidates to which one or more U2U relay path establishment procedures were attempted since the last failure event was reported; and
whether the first UE is allowed to try additional U2U relay UE candidates.

23. The method of claim 1, wherein when a U2U relay path to the second UE is successfully established via at least one U2U relay UE, the method further comprises:
monitoring and/or measuring the U2U relay path;
wherein the U2U relay path is monitored and/or measured in terms of at least one of:
one or more radio channel quality metrics on any hop between any two of the first UE, the second UE, and the at least one U2U relay UE that have a direct link therebetween;
a transmission failure rate;
a retransmission ratio;
one or more Quality of Service (QoS) metrics; and
one or more congestion metrics.

24-25. (canceled)

26. The method of claim 23, further comprising:
transmitting, to the network node, a report message reporting one or more measurement results associated with the U2U relay path via at least one of:
RRC signaling;
MAC CE; and
L1 signaling.

27. (canceled)

28. The method of claim 23, wherein a measurement is performed by the first UE according to one of: per destination UE, per neighbor UE, per hop, per service, per radio bearer, per Logical Channel (LCH), and per LCH group.

29-38. (canceled)

39. The method of claim 1, wherein the step of communicating with the second UE and/or at least one of the one or more U2U relay UEs comprises:
transmitting, to the second UE and/or at least one of the one or more U2U relay UEs, a request message; and
receiving, from the second UE and/or the at least one of the one or more U2U relay UEs, a response message indicating whether the request message is accepted or rejected by a network node associated with the second UE and/or at least one of the one or more U2U relay UEs.

40. The method of claim 1, further comprising at least one of:
receiving, from the second UE and/or at least one of the one or more U2U relay UEs, a report message via a sidelink connection;
receiving, from the second UE and/or at least one of the one or more U2U relay UEs, a message indicating that the U2U relay path needs to be reconfigured;
receiving, from the second UE and/or at least one of the one or more U2U relay UEs, a message indicating that one or more U2U relay UEs on the U2U relay path needs to be reselected;
receiving, from the second UE and/or at least one of the one or more U2U relay UEs, a message indicating that the U2U relay path needs to be released; and
receiving, from the second UE and/or at least one of the one or more U2U relay UEs, a message indicating that one or more specific RBs need to be remapped to a Uu path.

41. The method of claim 1, further comprising at least one of:
receiving, from the network node, a message indicating that the U2U relay path needs to be reconfigured;
receiving, from the network node, a message indicating that one or more U2U relay UEs on the U2U relay path needs to be reselected;
receiving, from the network node, a message indicating that the U2U relay path needs to be released; and
receiving, from the network node, a message indicating that one or more specific RBs need to be remapped to a Uu path.

42-75. (canceled)

76. A method at a UE for facilitating a first UE in performing a U2U communication with a second UE via one or more U2U relay UEs, the method comprising:
receiving, from the first UE, a discovery message or a link establishment request message; and
communicating with the first UE for the U2U communication based on at least the discovery message or the link establishment request message,
wherein the discovery message or the link establishment request message indicates at least one of:
one or more IDs of one or more U2U relay UE candidates;
one or more priorities associated with the one or more U2U relay UE candidates;
an indicator indicating whether a U2U relay UE candidate, which is not indicated in the discovery message or the link establishment request message, can be selected or not.

77-86. (canceled)

87. A UE, comprising:
a processor;
a memory storing instructions which, when executed by the processor, cause the processor to perform the method of:
receiving, from a network node, a message indicating control information for the U2U communication; and
communicating with the second UE and/or at least one of the one or more U2U relay UEs for the U2U communication based on at least the indicated control information; or
receiving, from the first UE, a discovery message or a link establishment request message; and
communicating with the first UE for the U2U communication based on at least the discovery message or the link establishment request message,
wherein the discovery message or the link establishment request message indicates at least one of:
one or more IDs of one or more U2U relay UE candidates;
one or more priorities associated with the one or more U2U relay UE candidates;
an indicator indicating whether a U2U relay UE candidate, which is not indicated in the discovery message or the link establishment request message, can be selected or not.

88-90. (canceled)
